(19) United States
(12) Patent Application Publication
(10) Pub. No.: US 2023/0075182 A1
(43) Pub. Date: Mar. 9, 2023

(54) SYSTEMS AND METHODS FOR MANAGING CONTENT FROM CREATION TO CONSUMPTION

(71) Applicant: Albhy Galuten, Santa Monica, CA (US)

(72) Inventor: Albhy Galuten, Santa Monica, CA (US)

(21) Appl. No.: 17/901,811

(22) Filed: Sep. 1, 2022

Related U.S. Application Data
(60) Provisional application No. 63/240,314, filed on Sep. 2, 2021.
(60) Provisional application No. 63/291,927, filed on Dec. 20, 2021.

(51) Int. Cl. G06Q 20/12; G06Q 20/40; G06Q 20/38; G06Q 20/36

(52) U.S. Cl. CPC G06Q 20/1235; G06Q 20/4015; G06Q 20/3825; G06Q 20/3827; G06Q 20/3674; G06Q 2220/00

(57) ABSTRACT

The present disclosure relates to content management systems and methods that may support, among other things, content storage, content identification, content collaboration, online services, payment settlement, electronic contracts, reputation, recommendation, and/or steganography activities. Consistent with various embodiments disclosed herein, systems and methods are provided to facilitate creation of works of any type, to collaborate with co-creators, to make that work available in the marketplace, and to provide for an architecture where the identities of all the creators involved may be bound to associated objects and/or identifiers associated with them. Being securely bound to certain identities and the identifiers, creative works may be distributed, and the associated credits and contractual obligations may remain with them and the associated remunerations and obligations may be respected and fulfilled.

### RELATED APPLICATIONS

This application claims the benefit of priority under 35 U.S.C. § 119(e) to U.S. Provisional Patent Application No. 63/240,314, filed Sep. 2, 2021, and entitled “SYSTEMS AND METHODS FOR MANAGING CONTENT FROM CREATION TO CONSUMPTION,” and to U.S. Provisional Patent Application No. 63/291,927, filed Dec. 20, 2021, and entitled “SYSTEMS AND METHODS FOR MANAGING CONTENT FROM CREATION TO CONSUMPTION,” the contents of both of which are hereby incorporated by referenced in their entireties.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### FIELD OF THE INVENTION

The present disclosure relates to content management systems and methods. More specifically, but not exclusively, various embodiments disclosed herein relate to content storage, content identification, content collaboration, online services, payment settlement, electronic contracts, reputation, recommendation, and/or steganography.

### SUMMARY

The world of content (e.g., media content) and governance is steadily moving online. Some things such as video and audio streaming services are solidly online, others such as banking and reservations are moving there relatively rapidly. However, the world of content creation and management has not moved there in its entirety. Creatives often submit their works via network services, but the creative process is still often manual and local.

Embodiments of the disclosed systems and methods provide for a complete system of creation and consumption. Certain instances herein may use the term Creatives or Creators to encompass songwriters and composers, performers, journalists, videographers, photographers, graphic artists, writers, architects, designers of 3-dimensional (“3D”) objects and any other person or group of people and/or machines that create content. Certain instances herein may use the term Creative Works to encompass the content made by Creatives. Consistent with various embodiments disclosed herein, tools are provided to create works of any type, to collaborate with co-creators, to make that work available in the marketplace, and to provide for an architecture where the identities of all the creators involved may be bound to associated objects and/or identifiers associated with them. Being bound the identities and the identifiers, Creative Works may travel freely throughout the world, the associated credits and contractual obligations may remain with them and the associated remunerations and obligations may be respected and fulfilled.

### BRIEF DESCRIPTION OF THE DRAWINGS

The inventive body of work will be readily understood by referring to the following detailed description in conjunction with the accompanying drawings, in which:

FIG. 1 illustrates a non-limiting example of a high level diagram of the elements in the system consistent with certain embodiments disclosed herein.

FIG. 1A illustrates a further non-limiting example of a high level diagram of elements in the system consistent with certain embodiments disclosed herein.

FIG. 2 illustrates a non-limiting example of a breakdown of file Storage elements, Service elements, and Settlement elements of a Cloud System consistent with certain embodiments disclosed herein.

FIG. 3 illustrates a non-limiting example of Storage elements of a Cloud System consistent with certain embodiments disclosed herein.

FIG. 4 illustrates a non-limiting example of further Service elements of a Cloud System consistent with certain embodiments disclosed herein.

FIG. 5 illustrates a non-limiting example of Settlement elements of a Cloud System consistent with certain embodiments disclosed herein.

FIG. 6 illustrates a non-limiting example of Creative Works Files within a Cloud System consistent with certain embodiments disclosed herein.

FIG. 7 illustrates a non-limiting example of a non-limiting example of a relationship between various kinds of Creative Work Files and various Creative Businesses supported by a system consistent with certain embodiments disclosed herein.

FIG. 8 illustrates a non-limiting example of Metadata and Meta-descriptors within a system consistent with certain embodiments disclosed herein.

FIG. 9 illustrates a non-limiting example of Identities of various types of entities consistent with certain embodiments disclosed herein.

FIG. 10 illustrates a non-limiting example of different kinds of Agreements consistent with certain embodiments disclosed herein.

FIG. 11 illustrates a non-limiting example of different groupings and types of Identifiers consistent with certain embodiments disclosed herein.

FIG. 12 illustrates a non-limiting example of Bindings of various elements of a system consistent with certain embodiments disclosed herein.

FIG. 13 illustrates a non-limiting example of elements of a Distributed Ledger and their relationship to the various repositories and providers consistent with certain embodiments disclosed herein.

FIG. 14 illustrates a non-limiting example of elements of an example Music Ecosystem consistent with certain embodiments disclosed herein.

FIG. 15 illustrates a non-limiting example of elements of an example Photography Ecosystem consistent with certain embodiments disclosed herein.

FIG. 16 illustrates a non-limiting example of elements of an example Film or TV Ecosystem consistent with certain embodiments disclosed herein.

FIG. 17 illustrates a non-limiting example of elements of an example Journalism Ecosystem consistent with certain embodiments disclosed herein.

FIG. 18 illustrates a non-limiting example of Service Components of a system consistent with certain embodiments disclosed herein.

FIG. 19 illustrates a non-limiting example of a relationship among participants of a system and connectivity of Content Package Links consistent with certain embodiments disclosed herein.

FIG. 20 illustrates a non-limiting example of a relationship among participants of a system and connectivity of Content Package Links as it might apply to an ecosystem consistent with certain embodiments disclosed herein.

FIG. 21 illustrates a non-limiting example of a different view of a Film or TV Ecosystem consistent with certain embodiments disclosed herein.

FIG. 22 illustrates a non-limiting example of a different view of a Journalism Ecosystem consistent with certain embodiments disclosed herein.

FIG. 23 illustrates a non-limiting example of relationships among participants of a system and the connectivity of Content Package Links as it might apply to a generic collaborative ecosystem consistent with certain embodiments disclosed herein.

FIG. 24 illustrates a non-limiting example of a view of Creators communicating with Aggregation and Distribution Services using a Bidding Engine consistent with certain embodiments disclosed herein.

FIG. 25 illustrates a non-limiting example of a view of the Reputation Services consistent with certain embodiments disclosed herein.

FIG. 26 illustrates a non-limiting example of a view of Access and Visibility Control Services consistent with certain embodiments disclosed herein.

FIG. 27 illustrates a non-limiting example of a view of the Search Components of the system consistent with certain embodiments disclosed herein.

FIG. 28 illustrates a non-limiting example of a view of Third Party Services that can be supported by the system consistent with certain embodiments disclosed herein.

FIG. 29 illustrates a non-limiting example of a view of the return of value from the Consumer back to the Creator consistent with certain embodiments disclosed herein.

FIG. 30 illustrates a non-limiting examples of services to aggregate the sources of revenue for creatives consistent with certain embodiments disclosed herein.

FIG. 31 illustrates a non-limiting example of a high level breakdown of various elements in a non-limiting example of a recommendation engine consistent with certain embodiments disclosed herein.

FIG. 32 illustrates a non-limiting example of a worksheet that may be used to demonstrate how Recommendation Credit Points may calculated consistent with certain embodiments disclosed herein.

FIG. 33 illustrates a non-limiting example of how song ratings and writer ratings may be calculated consistent with certain embodiments disclosed herein.

FIG. 34 illustrates a non-limiting example of how Ratings can be compensating for users who select the best rated works consistent with certain embodiments disclosed herein.

FIG. 35 illustrates a non-limiting example of components for collaborators and/or consumers consistent with certain embodiments disclosed herein.

FIG. 36 illustrates a non-limiting example of a Creator ecosystem consistent with certain embodiments disclosed herein.

FIG. 37 illustrates a non-limiting example of a music Creator ecosystem consistent with certain embodiments disclosed herein.

FIG. 38 illustrates a flow chart of a non-limiting example of a content management process consistent with certain embodiments disclosed herein

FIG. 39 illustrates a non-limiting example of a system that may be used to implement certain embodiments of the systems and methods of the present disclosure.

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the steps be executed only once, unless otherwise specified.

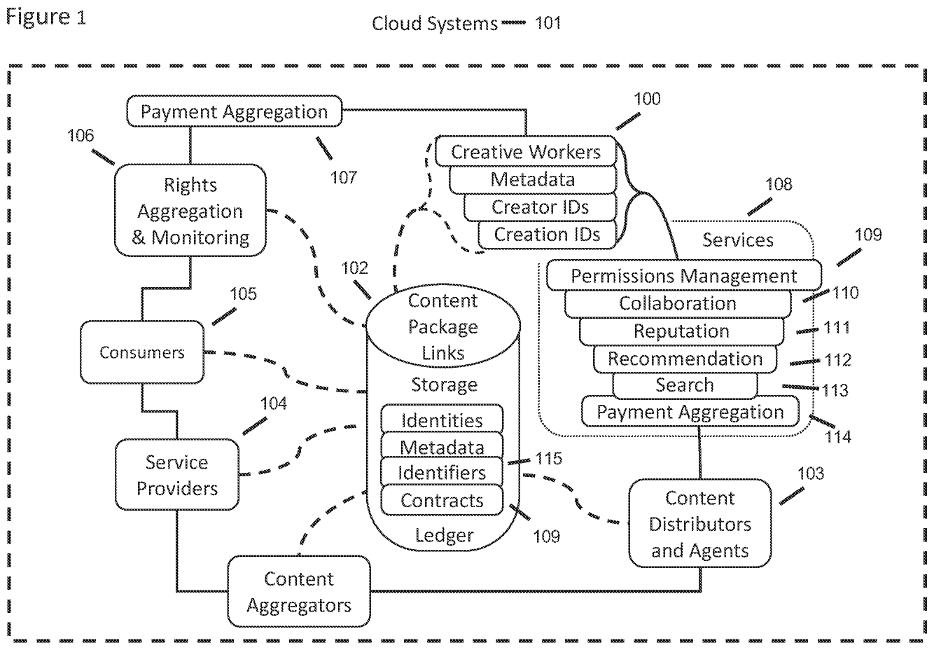

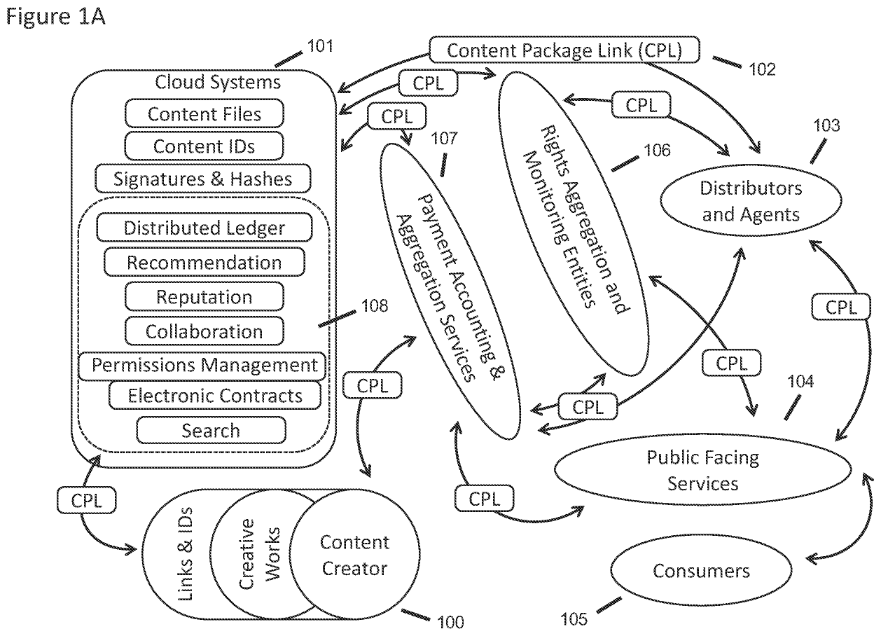

Embodiments of the disclosed systems and methods provide for a complete system of creation and consumption. A non-limiting example of the elements involved can be seen in FIG. 1 and FIG. 1A. The system may be centered around Cloud Systems (101) which may comprise a collection of services (108) for Creators (100). The first services may be designed to facilitate the creative process. When Creative Works and/or Content is made for distribution, other entities may be involved. These include, for example and without limitation, Rights Aggregation and Monitoring Entities (106), Distributors and Agents (103), Public Facing Services (104) and Consumers (105). The services provided by the Cloud Systems (101) may be virtual and can be located anywhere. They do not have to be co-located and they can exist in multiple instances. A high-level description of the elements and their relationships is as follows:

A Creator (100) may create a work of any kind (e.g., song, drawing, photograph, news article, 3D object, etc.). This creation may be an iterative process with the ability to store each iteration of the creative development in the Cloud System (“CS”) (101). For example, a songwriter might sing a first melodic idea into their phone and store it in the CS (101) as one or more Content Files. They might modify this over a period of hours or years with each iteration stored, cryptographically signed and hashed and registered in a Distributed Ledger (e.g., a Blockchain).

A variety of services may be used to facilitate a variety of interactions within the lifecycle of a Creative Work. For example, a Creator may want to work with other Creators on the Creative Work (Collaboration, 110), establish a contractual relationship with one or more of those Creators (Electronic Contracts via Permission Management Services, 109), receive feedback from professionals or other third parties (Reputation and Recommendation, 111, 112), search through their own content or look for material created by others (Search, 113), and/or have granular control regarding who can see their Creative Works and at what stage (Permissions Management, 109).

When there is desire to distribute the Creative Work commercially, commercial identifiers (Content IDs, 115) may be generated by Identification Bodies. These identifiers may include, for example and without limitation, International Standard Recording Code (“ISRC”), International Standard Work Code (“ISWC”), Digital Object Identifier (“DOI”), International Standard Book Number (“ISBN”), Entertainment Identifier Registry (“EIDR”), International Standard Audiovisual Number (“ISAN”), International Standard Content Code (“ISCC”) and others.

As a Creative Work travels through its life cycle, new identifiers may be added to the initial files—for example, after a song has an ISWC, if it is recorded for distribution, it may get an ISRC. If it is later added to a video, it may get an EIDR. Consistent with various embodiments disclosed herein, the files themselves do not need to traverse the network but rather all that needs to go from party to party is a Content Package Link (“CPL”) (102). This CPL (102) can point back to the complete package of media, metadata, rights, and/or to any of the individual elements. These elements may be updated and/or may be immutable.

For example, if a Photograph is licensed to an advertiser for one territory and the advertiser wants to use it in another territory, the identifiers and contracts bound to the content in the Immutable Ledger may be referenced by a CPL (102) which provides links for updating the rights and negotiating with the appropriate parties.

Following on to the next stage in the life cycle of Creative Content, the CPL (102) can be sent to the appropriate Distributors and Agents (103) who may to resolve the CPL (102) to review the content and the associated terms. The terms could include revenue shares and other financial terms, they could include credit requirements or distribution limits, or they could include a requirement to display a Uniform Resource Locator (“URL”). The contracts can be modified by agreement of all signatories. In some embodiments, there may be no limit to what the contracts (just like in the analog world today) can include and/or restrict. For example, a journalist with a hot story could submit it to a number of journalism outlets using a Real Time Bidding mechanism pointed to in the CPL (102) and the story could be carried exclusively by the highest bidder or the highest two bidders.

In many content markets, the Content may go from Distributors or Agents (103) to one or another Public Facing Service (104). There could be more stops along the way, for example a photograph could go from the Creator (100) to an Agency and from there to a Brand who would then send it out (perhaps as an advertisement) to a Public Facing Service (104) (e.g., a billboard, a radio station, a TV network, a newspaper, an online aggregator, etc.).

The Public Facing Services (104) may render content to Consumers (105) who remunerate the Public Facing Services (104) through advertising viewing or direct payment. These services often remunerate the Content Creators (100) through Rights Aggregators or Monitoring Entities (106) and/or Payment Aggregation and Accounting Services (107). Some of the Rights Aggregation and Monitoring Services (106) may comprise a Performing Rights Organization such as, for example and without limitation, the American Society of Composers, Authors, and Publishers (“ASCAP”) and/or Broadcast Music Incorporated (“BMI”). Others may be monitoring organizations that provide ratings like Nielsen or websites or newspapers that can report number of impressions or click-throughs or streaming services that can count plays or streaming services that can count subscribers.

The Public Facing Services (104) or the Rights Aggregators and Monitoring Entities (106) can remunerate the Content Creators (100) directly but, in many cases, the same creative work can generate revenue from a multiplicity of sources (e.g., a singer songwriter might receive money from: their Publisher, their Performing Rights Organization, the Mechanical Licensing Collective, their Record Company, the AF of M/American Federation of Television and Radio Artists (“AFTRA”) and individual Streaming services all for one song) and so might be aggregated by a Payment Aggregation and Accounting Services (107).

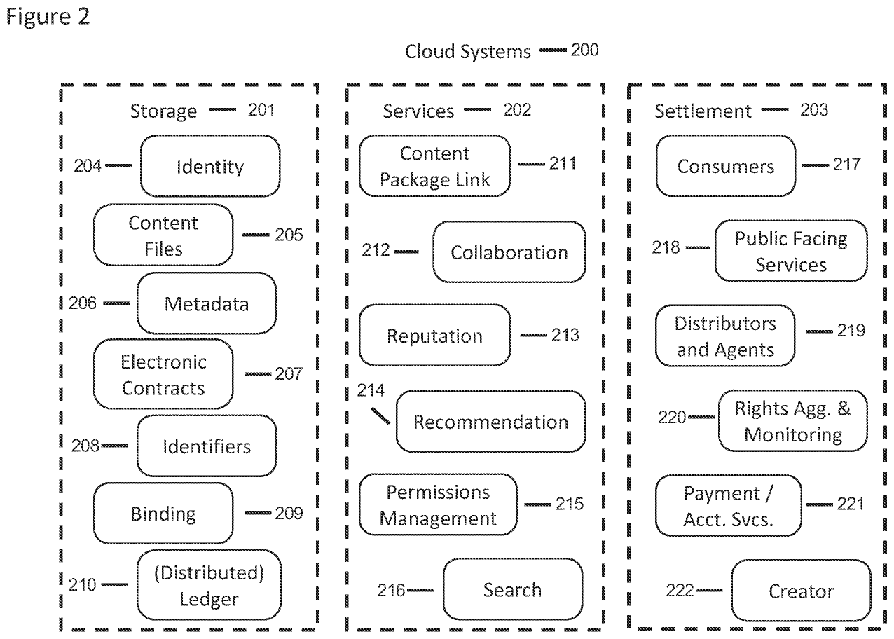

Having described the elements above let's begin to look in more detail at the CS (101). As shown in FIG. 2, the CS (200) may comprise at least three groups of elements: Storage (201), Services (202) and Settlement (203). Content and other Storage (201) can be distributed across an arbitrary number of storage devices which can be virtualized by a directory (e.g., potentially a single directory) which may be resolvable by common pointers that point to the object in the abstract as opposed to the specific instance of that object. In a similar fashion, Services (202) may be virtualized. Services (202) can be provided from any number of servers seamlessly to the user of that service. The architecture may further include Settlements (203) that may comprise fulfillment services for the obligations which are delineated in the agreements both contractual and statutory.

The kinds of files that may be stored in connection with various aspects of the disclosed embodiments may comprise, for example and without limitation:
Identity (204) may be a reference to an Identity provided by a commercial and/or government Identity Provider. That Identity can be any level of robustness as appropriate.
Creative Works/Content Files (205) like audio, video, text, photography, design documents, etc.
Metadata files (206) such as information about the documents like title, author, date of creation, content fingerprint or steganographic ID.
Electronic Contracts associated with the Creators and Creative Works
Identifiers (208) associated with the Creative Works (205) like ISBN, ISWC, etc.
Bindings (209) of the elements (e.g., as above) and/or a subset thereof associated with each creative work utilizing cryptographic hashes and signatures and the location of these bindings in the distributed ledger
Pointers to the location of the entries in a Ledger (210), which may comprise a Distributed Ledger.

The kinds of services that are provided by the Services (202) of the CS (200) may comprise, for example and without limitation:
Provisioning of CPLs (211).
Collaboration Services (212) which may provide the ability for Creatives to work together.
Reputation Services (213) which may use algorithms and/or the wisdom of the crowds to quantify the reputations of the participants
Recommendation Services (214) which may help participants find the right content to match their needs.
Permissions Management (215) which may provide access control as prescribed by the Creator (222) or their Contracts.
Search (216) through their own material to find an element (e.g., text string, metadata, etc.) or through the broad base of available Content and Creators (222) throughout the network to find material to license or Creators (222) to work with or distribute.

In addition to services provided for the creation and distribution of content are services that provide Settlement (203) of obligations or remuneration. These services may track the obligations through the chain from the Consumer (217) all the way back to the Creator. For example, this chain may pass from the Consumer (217) back through the Public Facing Services (218) who may pay Distributors or Agents (219) who then may pay Services that Monitor and Aggregate rights usage (220) and pay the Creators (222) sometimes passing through Services that Aggregate Payments and perform Accounting Functions (221).

Each individual domain consistent with various embodiments disclosed herein is discussed in more detail below.

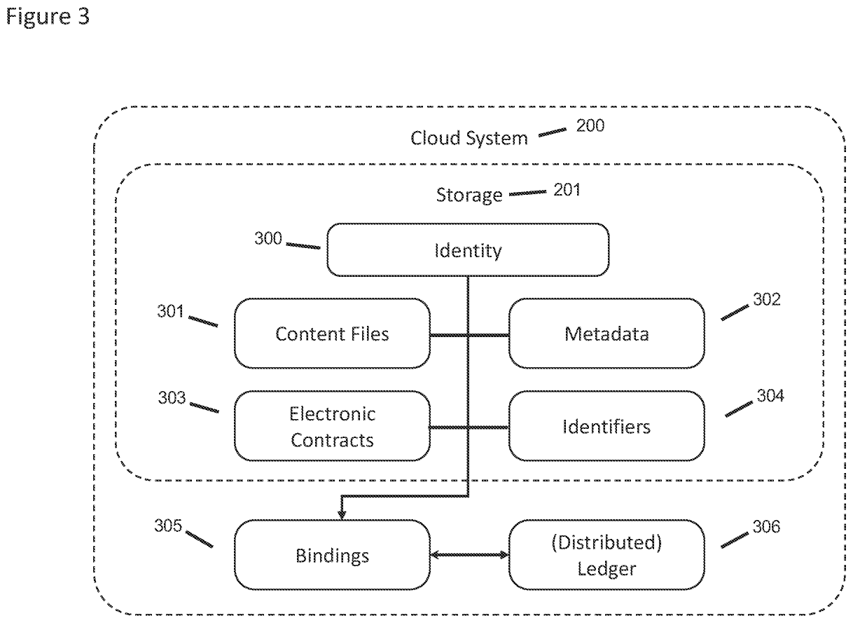

As can be seen in FIG. 3, the Storage (201) component of the CS (200) may include the Content Files (301) themselves such as, for example and without limitation, song recordings, photographs, videos, design drawings, patent ideas, and/or text of any flavor like a script or an article. It also may comprise the Metadata (302) associated with them such as the author, the date, the mood, the location or any relevant additional information. One specific file element is an Electronic Contract (303). This may generally be text of any format (though it could be a directed graph or include other graphics) which may apply to a legal relationship between or among entities. The fourth type of data that is stored are Identifiers (304). These could be ISRC, ISWC, DOI, ISBN, EIDR, ISAN, ISCC, and/or or any other identifier that is associated with the Content Files (301).

This brings us to the Bindings (305). When Binding two or more digital elements, they are taken together, a robust date is applied and then they are cryptographically hashed and digitally signed. These are typically bound with or to an Identity (300). This Identity could be a Person, a group of people or a legal entity of any type. This Binding (305) may create a unique identifier that can be generated by that exact combination of elements and can be used as provenance of the collection of elements, the Creator and the date and time of the hashing and signing. Once we have this robust digital record, it may be placed in an Immutable Ledger (306) such as a Blockchain that may or may not be distributed across multiple instances in multiple locations. Taken together, these content elements with their bindings can be used as proof of deposit or copyright. In various embodiments, the system may provide a mechanism to indicate that a Creative Work was placed in a repository at a particular time by a particular entity and that the data is immutable.

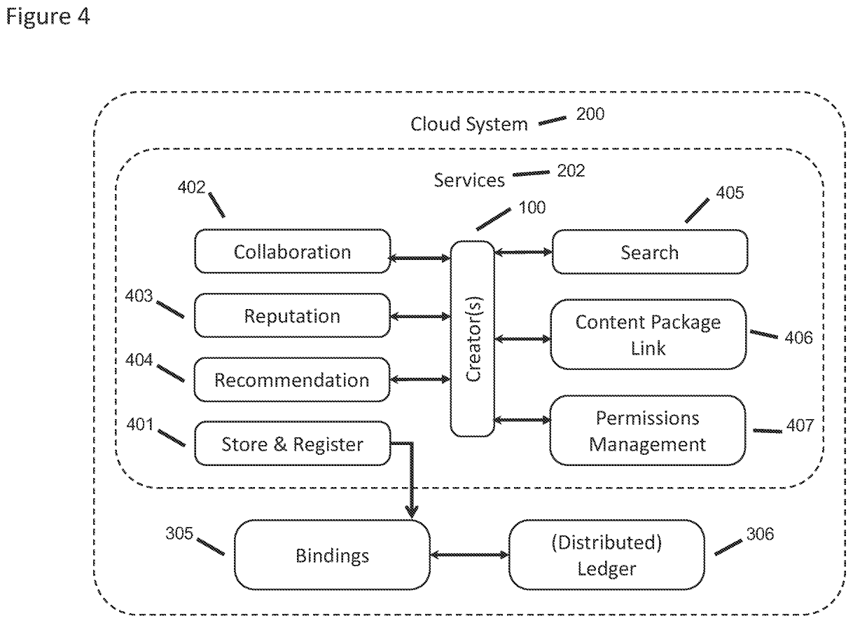

As can be seen in FIG. 4, there may also be Services (202) associated with the CS (200). A first set of services may be those that facilitate the creation and registration of the Content. When a Creator has the first version by, for example, singing a melody into their phone or taking a photo of a sketch or dictating the opening scene of a play, or describing a news event, this can be Stored and Registered. At this very first moment, the creation may be stored, time-stamped, bound (305) to the Creator's identity, signed, hashed and written to the Immutable Ledger (306).

After registering a first version of the Content a Creator may want to collaborate with other Creators. This Collaboration (402) may be first facilitated by messaging systems, text, audio and/or video. A Creator can send a CPL (406) to any entity or group of entities, and this may resolve to the created Content. However, these links may not be followed by anyone but instead by the people intended by the Creator who sends the link. This may be managed by a robust Permissions Management System (407) that controls who and when any entity can follow the link to the Content.

Creatives, however, may use other services as well. Because the system knows individuals and their histories and profiles (even if anonymous to others) the system can make Recommendations (404) as appropriate and weigh in on the Reputations (403) of the individuals or other entities (e.g., is this newspaper trustworthy). The last Service illustrated in this non-limiting high-level view is Search (405). Creators may be able to search for collaborators, but Creators may also be able to search their own corpus of material. If a writer has written thousands of pages of text (e.g., lyrics, scripts), they may need to be able to search based on content, genre, date and many other query types. Additionally, Services and Aggregators may benefit from the ability to search across large swaths of content from a multitude of Creators to find the appropriate for their needs.

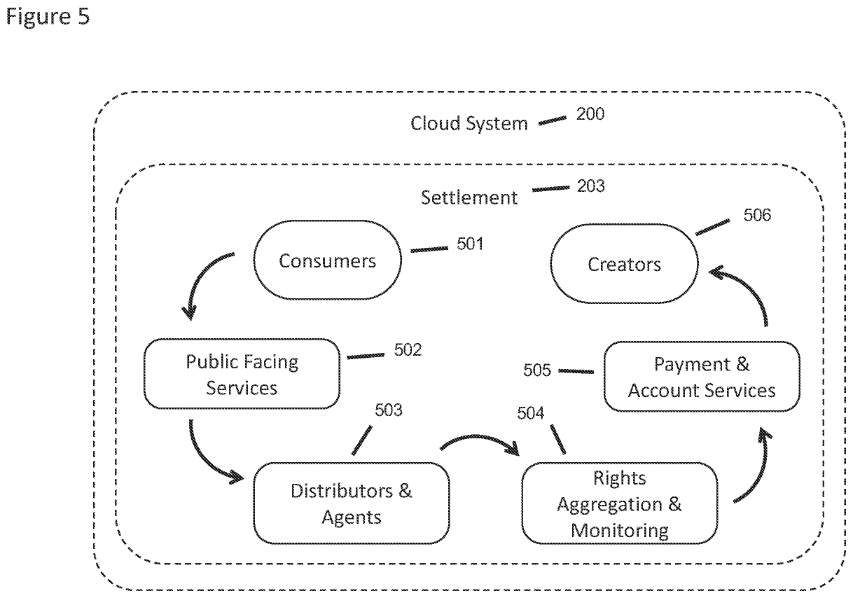

As can be seen in FIG. 5, there may be a Settlement (203) component to the CS (200). The Settlement (203) component may track remuneration and other forms of compensation (like ads or placement, etc.) from the Consumer (501) all the way back to the Creator (506), which in some implementations may roughly traverse the path originally taken by the content except in reverse. Consumers (501) may consume content in many different ways. They may listen to music streaming services or watch video services. They may buy downloads. They may surf the web and see advertisements. Consumers (501) may contract for buildings to be built, they may buy video games. Consumers (501) may buy books and hire photographers and read magazine and newspaper articles. Consumers (501) can be individual end users or ad agencies or contractors or web sites or 3D print shops. Nonetheless, these components may share, at a high level, some or all of the same architectural components. The Consumer (501) consumed some kind of media which they pay for by direct purchase, by subscription, by rental and/or by the consumption of ads. They may buy these from Public Facing Services (502) like music or video download or streaming services, gaming companies, graphic designers, bookstores, newspapers, photography services, and/or any number of other services. These Public Facing Services (502) may compensate the Creators (506) directly but more often they may go through one or more intermediaries like Distributors and Agents (503).

In music, these intermediaries may be complex and can include music publishers, record labels, managers and/or agents. In other domains they can go through advertising agencies, theater owners, book publishers, newspaper and/or magazine publishers, web sites, game publishers, etc. For some industries, there are entities that do rights aggregation and monitoring (504). These include Performing Rights Organizations, unions and guilds, music publishers, mechanical licensing entities, and/or wholesale distributors. When a Creator (506) sells directly to a Consumer (501), the remuneration path may be simple—the Consumer (501) pays the Creator (506). However, in some industries like music and film there may be a need to aggregate payments (505) from multiple services and intermediaries. For example, in music a single singer songwriter might have to aggregate payments from streaming services, record labels, music publishers, Performing Rights Organizations, mechanical licensing collectives from film and TV companies for sync licenses from co-writers or recording artists. There may managers and agents who coordinate and aggregate these payments for high end Creators (506), but part of this disclosure is a mechanism to aggregate these payments using software and a robust chain of handling and control of identities, identifiers and automated electronic contracts.

Storage

There are many types of files that may be stored that are associated with a Creator and their Works. Some of them are the creative elements themselves including multiple versions. Others are metadata about those elements, and this may include various identifiers. In addition, there may be pointers or references to multiple elements either stored in the same (virtual) location or stored by others in other locations. What follows is a detailed breakdown of the Storage Components.

Creative Works Files

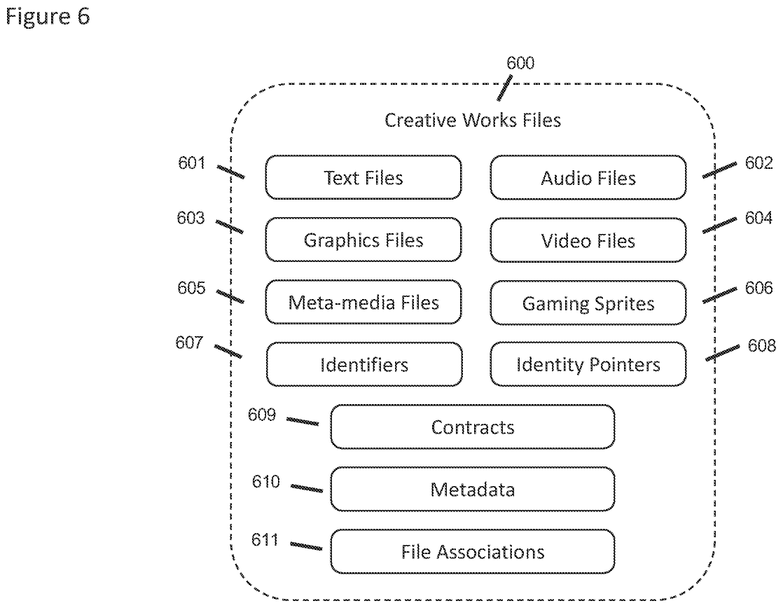

Referring to FIG. 6, the Creative Works Files (600) or simply the Works may be digital versions of the actual works the Creator has created. A Work may be a versioned set of metadata values along with a collection of Textual, Graphical or Audio Artifacts. Artifacts can be versioned by artifact type (e.g., Text, Graphical, Audio, etc.). What follows is a list of many of those elements, but one practiced in the art can easily imagine many others, and this listing is not to limit the kind of Works there might be. Works Files can be grouped in many configurations. For example, an audio file could be part of a music recording or part of a podcast or film notes or a journalism field recording. There are similar functions for almost all types of media in almost all vertical markets. First, as seen in FIG. 6, there is the breakdown of media types and references:
Text files (601) can be any kind of file, even if the service does not have the ability to render the file. Plain text, Word, Google docs are common but also formatted files like Final Draft for scripts or structured text like C++ code or XML.
Audio files (602) can also be of any type, even if the service cannot render it. MP3s, WAV files, lossless codec files but theoretically this could include photos of waveforms or of the pits and lands on a compact disk (“CD”). They can be in monaural or stereo or surround or location based (e.g., Dolby Atmos) or multiple tracks such as from a Digital Audio Workstation. The sounds could be physically modelled or a representation not as a waveform but as a set of parameters. Any technique that can be used to represent an audio file in digital form can be used.
Graphics files (603) can include any type of graphics file. These could include photos, scans of drawings, digital files in multiple layers, filtered, raw, compressed, ordered, etc.
Video files (604) can include any traditional video files, compressed or not but also newer formats like point-cloud or multiple layers or game engine files.
Meta-media files (605) include files that describe data that may be used by the media files. This area is meant to include elements that are not typically considered part of Metadata like watermarks, fingerprints, fonts, color palettes, sprite maps, layer descriptors, etc.
Gaming sprites (606) may be graphical elements, commonly used in gaming but which can be part of video or image files and can be controlled in concert with other elements or independently.
Identifiers (607) may include standardized identifiers like ISRC, ISWC, DOI, ISBN, EIDR, ISAN, ISCC but could include any code or number used by this system or another system to identify Creative Works.
Identity pointers (608) may point to identified parties. Typically, these are Creators, but they could also point to corporate entities or representatives of Creators. There are many services that provide Identity and many degrees of robustness from a simple email or phone all the way to physical attestation provided by certified authenticating parties. These Identity Pointers may point to them.
Contracts (609) may be agreements between parties. These can be scans of physical contracts but, most often may be digital agreements agreed to by the parties and signed digitally. The contracts can be used in a court of law to verify an attestation but also can be actionable code fragments or directions telling entities like financial institutions what to do.
Metadata (610) files can include some of the Meta-media files above depending on the format of the file. For example, many audio files have defined fields for things like Artist, Album, Track title, Genre, Album artwork and Track number. Metadata (610) for other kinds of assets might include location information, names of people, places or things in media files, chord charts, time, and date of capture (which may be different from time and date of deposit/copyright), URLs associated with sections of a graphic, etc. Genre may be a piece of Metadata (610) that describes the kind of Title and is used to categorize Titles.
File Associations (611) may be the links that connect all the different elements together. For example, if I have a photo with a watermark, the watermark file would be associated with the photo. Access to that watermark file might be restricted for security purposes. Other linkages are more elementary like a Composer linked to the Song then linked to the Performer and also the Recording. Also, in music there may be multiple Identifiers that may need to be linked like the initial copyright data (e.g., hashed file signature and date) to the ISRC and the ISWC.

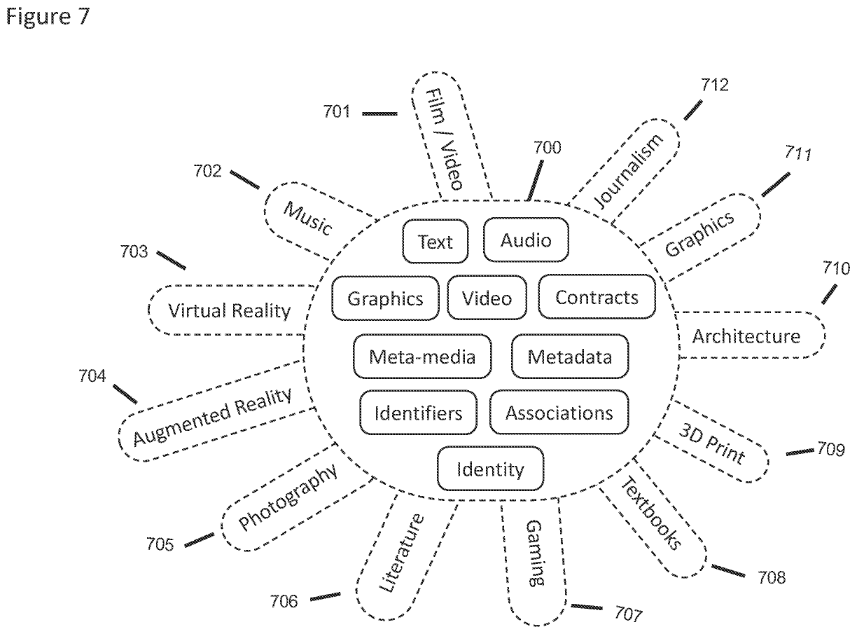

As shown in FIG. 7, these file types (700) may also be viewed from the perspective of the industries they serve. Though Creators may work in multiple industries, they may tend to see the media elements from the perspective of the industry for which it is created. Though we are fully aware that the industry boundaries are blurring and changing all the time it is still useful to view the elements from the perspective of the industry they are meant to serve. So, the elements viewed from a creative industry perspective view may include but not be limited to:
For Film or Video (701): Video recordings in any format, Scripts, Storyboards, Animations, and other notes about shooting such as, but not limited to: locations, props, makeup, virtual special effects (“VFX”) notes and elements, color palettes, lighting notes, point cloud elements, image capture, motion capture, 3D rendering and associated elements and holographic elements, etc.
For Music (702): Audio recordings, Digital Audio Workstation files and settings, Video recordings that include audio, Scans, or photographs of music notation of any kind, Music notation in any format, e.g., music printing software files, MIDI files or any other mechanism of notating music, video files, etc.
For Virtual Reality (703) and Augmented Reality (704): background plates and layers, sprites for overlaying, text for overlaying, 3D images for placing in space, volumetric information, map information, motion triggers, location triggers, azimuth information, z order information, image capture information, data about captured images, etc.
For Photography (705): Images, Settings, f stops, filters, etc., Location notes and notes on content or composition, digital data such as layers, color settings, palettes, etc.
For Literature/Fiction & Nonfiction (706) and Textbooks (708): Written text in any format, Audio, or video recordings of spoken or sung word, page references, indices, tables of contents, style guides, and or fonts, graphics or audio or video associated with the written word, ordering directions (e.g., for text that can be rendered or consumed in multiple orders), etc.
For Gaming (707): sprites, game architecture, storyboards, background graphics, scripts, decision maps, music elements, spoken elements as recordings or as text, emotional cues, action cues, location maps, level maps, etc.
For 3D, 3D Printing and Holograms (709): graphics files (e.g., computer aided drafting (“CAD”), etc.), materials list for printing, printer specific files, holographic information for projection, rendered views, motion capture data, point cloud data, background data, etc.
For Architecture (710): CAD files, graphics elements, location metadata, materials and materials lists, views (front, top, etc.), rendered views, versioning information, structural engineering data, soils data, inspection data, construction history, etc.
For Graphics/Graphic Design (711): Scans of drawings, Digital files as images, Digital files as elements, components, layers, color palettes, etc.
For Journalism (712): Written articles or notes or drafts, Audio or video recordings of such, Bylines, location notes, outlines, proposals, etc.

Metadata Files

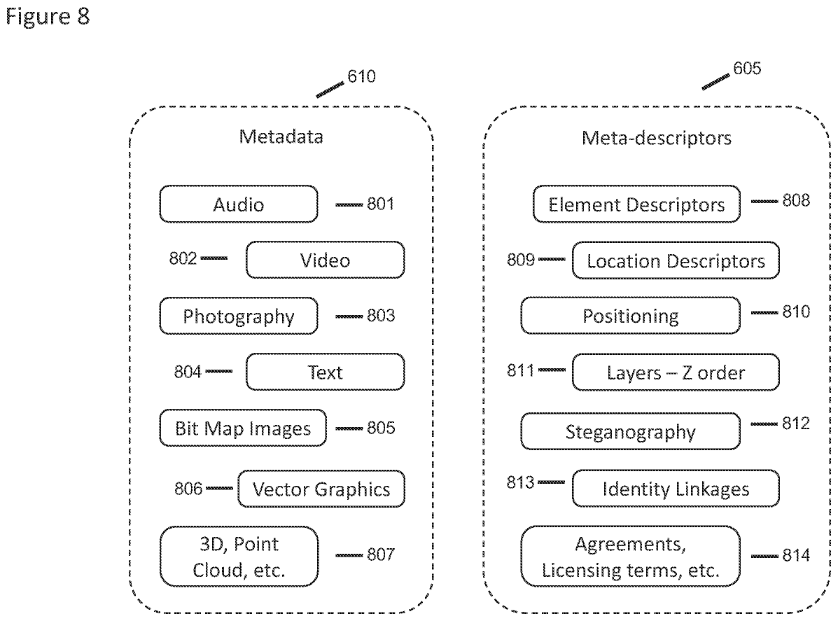

As can be seen in FIG. 8, there may be many different types of metadata—both what is traditionally thought of as Metadata (610) and also what may be referred to herein as Meta-descriptors (605). The Metadata files (610) are often included in the file formats. Some examples (but not all) of Metadata files (610) that may be included with the files comprise:
Audio (801): MP3, Advanced Audio Coding (“AAC”) and other audio formats include fields for things like Artist, Album, Track title, Genre, Album artwork and Track number.
Video (802): Author, Date Created, Location Shot, Camera Information, Upload Date, etc.
Photography (803): location information, time and date, textual descriptors, camera settings, lenses used and even steganographic information inserted by the camera at time the photograph was taken.
Text (804): Font, Color, Tabs and Indents, Kerning, Color, etc., etc.—generally this comes with a meta formats like Microsoft Word, Google Docs, Final Draft, Scrivener, Notes, etc.
Raster (or bit-mapped) graphics (805) files: mostly formatted in application specific formats like Photoshop, Corel PaintShop, GIMP, etc. which may include Exif Tags like Bits per Sample, Exposure Time, Image Length, Image Width, etc. as well as proprietary tags like palette and layer information. There may be programs to convert between different metadata tags in different programs.
Vector Graphic (806) files: mostly formatted in application specific formats like Adobe Illustrator, CorelDraw, Sketch and Affinity Designer but usually support standardized formats like EPS and SVG.
Others (807) include 3D files and Architectural Drawings. Interoperability may be provided by common formats like STL and Collada which can be exported to and that can be read and imported by most 3D programs. Others (807) may comprise, Point Cloud Images, Gaming images, sprites, etc.

As can be seen further in FIG. 8, Meta-descriptor files (605) may include files that describe data that is used by or describes the media files. This area is meant to include elements that are not typically considered part of Metadata (610) like watermarks, fingerprints, chord charts, fonts, color palettes, sprite maps, names of people, places or things in media files, URLs associated with sections of a graphic, locations of previous versions, location of licensing terms, etc. This also may include dynamic material that is added later. For example, if a photograph has been modified, there may be information about the original photograph but there may be information about how it was later modified. Also, there might be information about the original photographer but later have information added about the editor or information about the licensing terms or about the representative of the photographer.

The key point is that, as a Creative Work travels through its life cycle, there can be much ancillary information whether or not that is captured by the device or format at the original creation or data which is added over time due to transformation or additional uses or identifiers.

Though there may be no limit to the number and/or kind of Meta-descriptor (605) files, non-limiting examples may include one or more of:
Element Descriptors (808) describe the pieces of a creative work. For example, some element descriptors might be as follows:
   For music: chord sheets, music notation, MIDI files, lyric sheets, sample sound files, Digital Audio Workstation files, etc.
   For photographs: descriptive location information like “at Joe's bar” (as opposed to an address that might be in the metadata) or “at sunset” or using such and such a lens or a filter or f-stop.
   For other graphics files: layer information, palette information, versioning information or references to graphics elements that were imported, etc.
   For video files: the name of the actors or camera operator or cinemaphotographer or director or information about the props or costumes. The list of possibilities may be long but information can be associated with other information. This scene footage may be associated with a particular movie or TV show or news event or documentary. Elements of a production can point to each other and to a meta file that contains the meta-information including history and provenance and changes made by whom and when.
   For Journalism: the writer can reference the context of the event, others working on the event like photographers, the employment status of the journalist or any other information that might be relevant later.
Location Descriptors (809) are described briefly above for a few different environments but are addressed separately because, in this environment, they may be unbounded. For example and without limitation, the location could be at a conference or at a riot or underwater or at an elevation or at a sister's wedding.
Positioning (810) can overlap with location, but it may often have to do more with location in relationship to another element. For example and without limitation, this leaf is in front or that tree or this ball is on this field or this element is related to this other element or this article should be in the second section of the paper or this violin line should only come in when the karaoke singer is not singing.
Layers and Z-Order (811) may apply to graphics files but can apply to gaming elements like sprites or real-time elements as in augmented reality where something could appear, for example to be partially behind a rock or peering through a window. There can be a Z-order to audio with one element attenuating another.
Steganography and Fingerprints (812) are metadata either in or about media. Steganography like watermarks, can be embedded in audio or visual files such that they can only be found by the appropriate reader. Fingerprints may be snapshots of files so that the metadata associated with the original file can be found even when it is not present in the file itself. Both Steganography and Fingerprints may live in external data structures that need to be bound to the original in an indirect way. This information may be associated with the original files but also with the other associated elements like creators and publishers and distributors and journals and agencies.
Identity Linkages (813) may link to the identities of the people or entities that have either worked on the Creative Work or have a business relationship to it. For example, a recording of a song can point to the identity of the composer, a piece of film can point to the script writer but also to the camera operator or to the director or to the studio or the producer who is funding the project. Any Creative Work can point to the contract that governs it use. The identities or some or all the participants in the creative process or value chain of control or remuneration can be linked.
Agreements, Licensing Terms, etc. (814) may be the mechanisms that govern the use of the Creative elements and are discussed in more detail below.

Identities

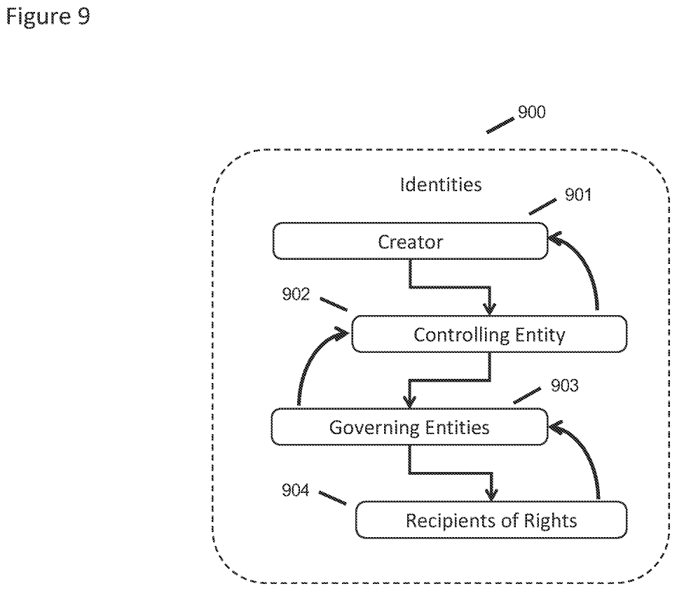

Identities may be different from Identifiers. Identifiers may typically identify all or part of a Creative Work. Identities may identify the people or entities that are referenced in the metadata or agreements and can exercise control over some aspect of the Work or may be remunerated for its use. As can be seen in FIG. 9, in some embodiments, there may be basically four buckets of Identities:

A Creator (901) may be the entity or entities that have done the actual creation. This may be the songwriter or the photographer or the scriptwriter or the film director or the video game creator. Once a Creative Work is created by a Creator (901), it may have legal protection (though the Creator (901) may have to demonstrate when the Work was created and/or realistically when it was registered). Creators (901) may be one of more individuals who have made the Creation and they may each have some mechanism of Identity. Identities have historically been paper documents such as a Passport or a Driver's License. In the online world, identity usually comprises a unique username like an email address that is associated with a password or a token on some kind on a device. Often, for verification purposes, multi factor authentication is may be used by an entity that wants access to their Creative Works stored online or to the statements associated with their remuneration or to the remuneration itself. Creators (901) can sign documents using digital signatures to implement electronic signatures in a cryptographically protected way. Creator identities can be quite robust as in the case where a Creator (901) has signed up with a payment entity and given photo identification, an email address, a physical address, and a Social Security number. In various embodiments of the system envisioned here, Creator Identities, after a number of reasonably robust assertions, may be stored as part of the CS. These identities can be stored in multiple distributed locations such as in an immutable ledger. These Identities may be bound to a Creative Work by the System so that every Creative Work has one or more Creators (901) associated with and/or cryptographically bound to it.

Control or a Controlling Entity (902) may be, in this context, the ability to determine what entities may utilize the Creative Work. Control can be ceded to a Governing Entity (903) by agreement or statute. A Governing Entity (903) may be a legal entity that has control over the disposition of the Work. For example, a photographer can license a photograph to an Agency which may then have the right to monetize that photograph by, for example, using it in an advertisement. A scriptwriter typically licenses a script to a film or TV studio and gives them broad license to monetize and modify that script in pursuit of a film. The film may be created very much under the direction of a Director who has given control to a greater or lesser degree to the studio to exploit that film or TV show.

In many creative fields, control is shared with or given to an entity based on a Contractual Agreement between the Creator (901) and the Controlling Entity (902). However, sometimes the right to exploit a Work can be given by statute. For example, in the case of music copyright once a Work (e.g., a song) has been released to the public by an entity (e.g., typically a recording artist who may or may not have written the song) anyone may record and release or perform that song and the remuneration is determined by statute and by a federally mandated Copyright Arbitration Board which may set the rates for remuneration for all similar Works.

Another set of entities are those who exploit and consume those rights. These Recipients of Rights (904) may be the consumers—individuals who purchase photographs, listen to music, watch films, etc. and those services that provide Creative Works to those consumers like streaming music services, television networks, movie theaters, advertising agencies, etc.

In total, looking at FIG. 9 we see the flow of rights and control from the Creator (901) to the Controlling Entity (902) to the Governing Entities (903) to the Recipients of Rights (904) with the remuneration typically traversing the same and/or a similar path in reverse from the consumer back to the Creator (901).

Electronic Contracts

Content-to-consumer relationships may be governed either by contractual agreement or by statute (laws). Statutes, set by governments, Copyright Arbitration Boards or International Conventions, can determine the rights, restrictions and rates for the use of copyrighted material and typically vary from territory to territory. Contracts can, of course, say most anything (legal) the parties agree to. Some content can be impacted by both statutory agreements and contractual agreements. This can make for very complex relationships between the Creators and the Distributors. Though difficult for many Creatives to keep track of, if properly encoded, this can be achieved using computer systems. Encoding statutory rates into computers to settle payments may be implemented, though it may rely on the receipt of accurate data to determine those payments. Encoding rates and variables into contracts, which may be based in a multitude of factors, can be arbitrarily complex.

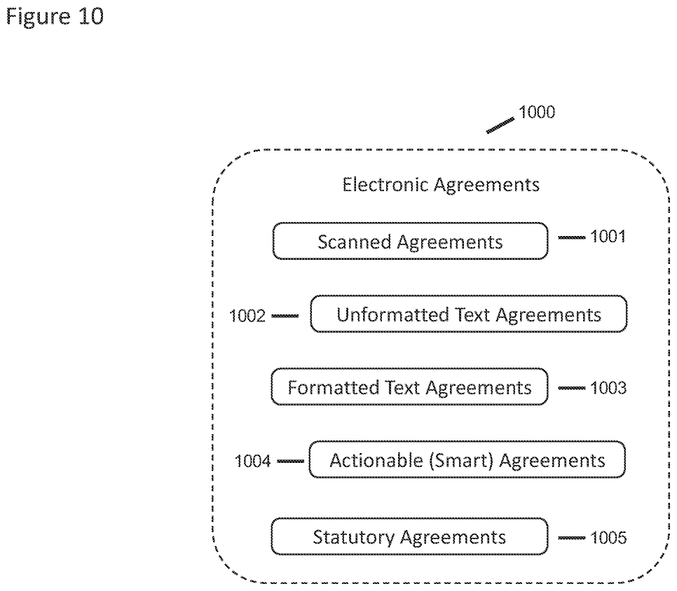

As can be seen in FIG. 10, there may be different kinds of Electronic Agreements (1000). The first, Scanned Agreements (1001) may be unformatted graphical representations of contracts. Artificial intelligence is gradually making scanned text parsable and the analysis accurate. The second may be the parsing of Unformatted Text (1002). This can yield the same and/or similar results as Scanned Agreements (1001). Taking action based on non-explicit text has complexities that can be daunting. Some clauses may intentionally ambiguous or not definitive and if the definitions or parse-ability are not clear, it may be hard to take automated actions based on them. Next, we enter the area of Formatted Text Agreements (1003). By this we mean agreements where the clauses are defined. These may be known as Electronic Contracts and may have pre-defined clause meanings. These can be interpreted by back-end payment systems, but may not always be interpreted accurately. If, however, an agreement has defined clauses, for example the splits between two songwriters and the definition of who has control of licensing and what territory it is legal and active in, the contract parsing system could make accurate assessments of the obligations contained within the contract and have the connections to the necessary financial instruments to execute on the contract. Smart Contracts (1004) are defined specifically to take action in the event of a triggering activity. This could be that 4,000 people have read my news article and the licensee has agreed to pay me a specific rate for views above a certain number and that remuneration is to go into my account with the payee location and timing defined. Finally, certain rights and/or obligations may be defined in one or more applicable Statutory Agreements (1005) that, in some embodiments, may articulate statutory requirements that may or may not be agreed upon by the parties explicitly.

Identifiers

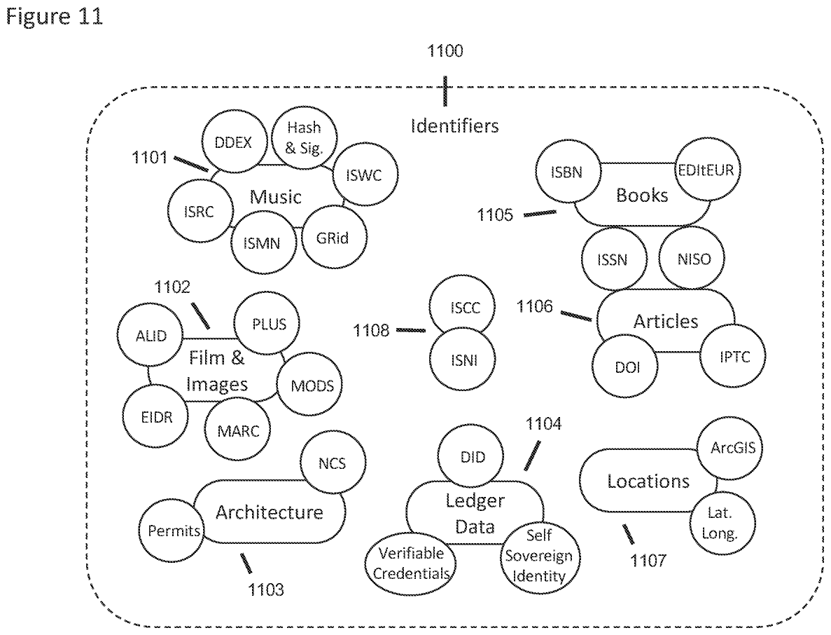

Creative Works often have standardized identifiers that are provided by various Standards bodies. Non-limiting examples of these are shown in FIG. 11. This diagram is limited to standardized identifiers that are controlled by public facing bodies. There are many other private identifiers. Retailers may have proprietary Stock Keeping Units (“SKUs”), Banks may have account numbers that are kept from colliding with other bank's numbers by association with the bank IDs like routing numbers in the US or SWIFT or IBAN numbers for international routing. Standardized codes may be particularly applicable in connection with various disclosed embodiments.

Looking at the diagram, we have broken the Identifiers (1100) into domains of content. Part of this disclosure speaks to how these different Identifiers (1100) can be bound together but for now we will just discuss some of the kinds of Identifiers (1100) there are. The Identifiers (1100) described herein are by no means exhaustive but are provided to give a sense of the scope of different Identifiers (1100) to understand the value of binding them to the content and the content Creators.

First are Music Identifiers (1101). Music is particularly complex in the identifier space because there are multiple creators for the same work and the Work goes through many iterations. First you may have one or more songwriters who create a song which can be identified in multiple ways. The first iteration can be stored in the cloud and hashed and signed. This creates a unique ID that can be used to identify that recording. There could be dozens of versions of the song as the writer(s) go through the writing process and each of those iterations can have its own unique hash and digital signature which creates a unique ID for that version of the song. Once the song is “finished” it can be registered with a Performing Rights Organization (like ASCAP or BMI) and they will send back an ISWC which should theoretically be associated with every recording of that song but is often not.

When the song is recorded by a performer and prepared for release it may be given an ISRC. It may also be distributed with Digital Data Exchange (“DDEX (”) structured information including Parties identified in the DDEX Party Identifier Registry. A sheet music version of the song or recording can also have an International Standard Music Number (“ISMN”) and the digital release may also have a Global Release Identifier (“Grid”). One non-limiting purpose of the system described in this disclosure may be to bind the identifiers together so that having any one of them will lead to resolution to the other identifiers. This binding could be done in any number of ways. The various IDs could be placed in a database but that would require maintenance by a central party and many agreements regarding access.

The system proposed here may begin with the Creator having control of their works while providing them the ability to delegate obligations and responsibilities contractually while maintaining dynamic access to and control of those obligations and responsibilities. Various embodiments of the disclosed systems and methods facilitate a Creator-centric architecture. The basic mechanism of binding is described in more detail below but briefly described, a creative work may be stored in the cloud and bound to a Creator's ID by cryptographically hashing and signing the combined elements. This signature and hash may be placed in an Immutable Ledger (like a blockchain, and may be distributed). When another identifier is added, the new compound file may be signed and hashed and placed in the Ledger. The files can be stored anywhere and if long as the hash and signature match the Immutable Ledger, it may be proof of provenance. This process can be applied not only to the addition of identifiers but also to modifications of the Creative Work. If, for example, an artist creates a graphic design using two layers in a Photoshop file format. That file may be stored in the cloud and bound to and hashed and signed with the Creator's ID. Now suppose that artist wants to license that artwork to other artists to add more layers. The artists can agree by digital contract to the terms of that relationship (for example if the second artist sells the resultant artwork the original artist gets 50% of revenue and must be credited) and that contract may be stored in the cloud and bound to the artwork in question and to the two creators and the contract and the whole thing may be signed and hashed and stored in the Immutable Ledger. In this way multiple creatives can work together, and the results of that work can be distributed, and participants can be remunerated.

To give a few more examples of the kinds of works and identifiers that may be bound, let's look at FIG. 11 again. The film and image identifier space (1102) may be populated by many identifiers, including Logical Asset IDs (“ALID”), Entertainment Identifier Registry (“EIDR”), Picture Licensing Universal System (“PLUS”), Metadata Object Description Schema (“MODS”), Machine-Readable Cataloging (“MARC)” identifiers, and/or similar identifiers. As a Creative Work traverses through different creators and distributors it may pick up multiple identifiers just as in the music example above as well as contractual obligations and the identifiers and Creator IDs can be immutably bound and linked to for access by third parties.

For Books and Articles (1105 & 1106) we have: ISBN, European Book Sector Electronic Data Interchange Group (“EDItEUR”), International Standard Serial Number (“ISSN”), National Information Standards Organization (NISO), DOI, International Press Telecommunications Council (“IPTC”) identifiers and others. For location tracking there is Aeronautical Reconnaissance Coverage Geographic Information System (“ArcGIS”) and latitude and longitude. In architecture there is the National CAD Standard (“NCS”) and a multitude of identifiers for building permits and codes and commissions. Even regarding standards for Immutable Ledgers there are Decentralized Identifiers (“DID”), standards for Verifiable Credentials (tamper-evident credentials that have authorship that can be cryptographically verified) and Self Sovereign ID (“SSID”).

Additionally, there may be some standardized identifiers that are not limited to one or two different kinds of media like International Standard Name Identifier (“ISNI”) and the ISCC.

Bindings

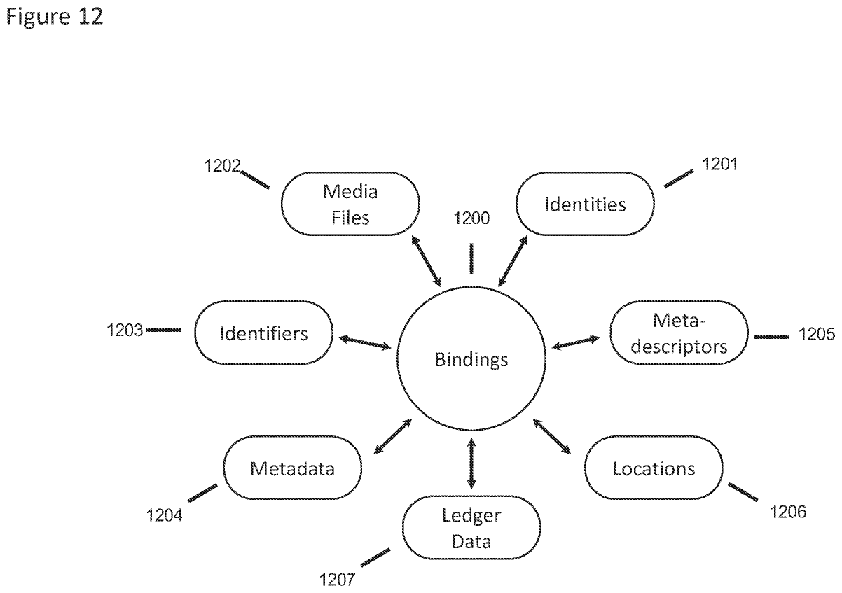

As can be seen in FIG. 12, there may be many elements that can be bound together via one or more Bindings (1200): Identities (1201), Media Files (1202), Identifiers (1203), Metadata (1204), Meta-descriptors (1205), Locations (1206) and Ledger Data (1207). There are many techniques for binding different elements. One method consistent with various disclosed embodiments may be to append files together or put them in a wrapper and then to hash the file and then encrypt and sign the file. In our universe, we may be frequently updating the compound file. So, for example, suppose I have written a song with a co-writer. The song could be hashed and signed and robustly stamped with the time and date and our IDs so that we know the Who, the What and the When of the creation of this song and also that the file and associated metadata has not been tampered with. We can put a link to the file and the metadata in an Immutable Ledger like a blockchain or in a database. Now suppose we have signed an electronic contract together that stipulates our shares of the song. This contract may also hashed and signed to confirm the Who, What and When of the contract. Within the contract is a pointer to the Ledger entry of the song. The Ledger entry of the song may also updated to reference the Ledger entry of the Contract. In this way, if you have the entry to the Song or of the Contract, you can find the other.

Now suppose you register the song with your Performing Rights Organization, and they send you an ISWC identifier. You may add this ISWC to the Ledger entry of the Song and hash and sign the new file. Now our Ledger entry for the Song has all the data associated with the Song, the Contract and the ISWC. I can now send anyone the link that points to the Ledger Entry and know that it points to the latest versions of the associated files and metadata and that they have not been tampered with. This process can continue as more information is added. The song could be recorded by a recording artist and that version could be referenced in the metadata of the original Ledger entry and that recording could be assigned an ISRC that can then be added to the original Ledger entry. The address of the original entry does not have to change and going forward anyone needing to know about the original song for example, for remuneration purposes, can follow the original link to get the identity of the songwriters. If another performer also records the same song, they can link back to the original song data as well and if a Publisher, for example, wants to know what performers have recorded the song, they can link to the original Ledger entry and look up all the performances of that song that have been linked to the original song Ledger entry. These links may represent a perpetual, immutable ledger containing the history of a Creative Work, the associated parties (Identities (1201)), media files, contractual agreements and identifiers with pointers to all of the related files and parties.

Distributed Ledger

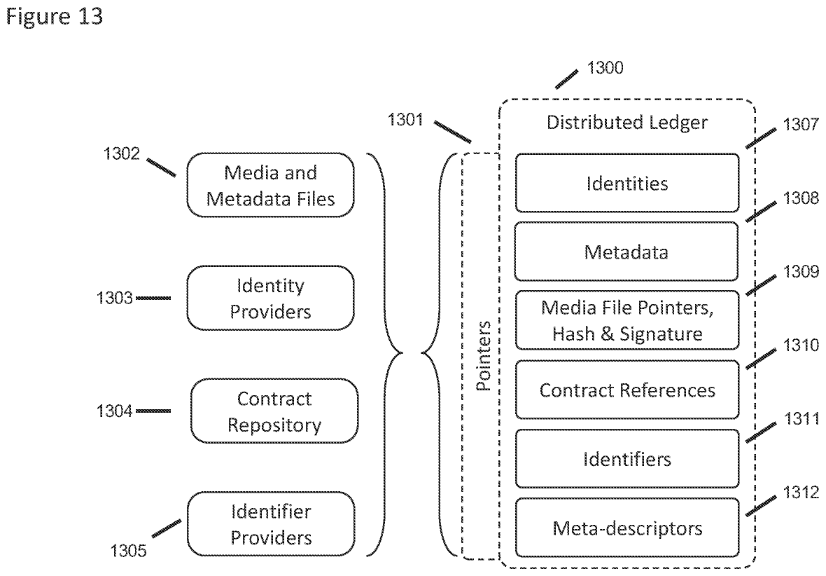

At least one method of binding the various elements together is to use a Blockchain Distributed Ledger. As can be seen in FIG. 13, some elements may live in the Distributed Ledger (1300) like the Identities (1307) received from the Identity Providers, some of the Metadata (1308), Hashes, Digital Signatures of and Pointers to (1309) the Media and Metadata Files, References to the Contracts (1310), Identifiers (1311), and Meta-descriptors (1312). Other elements may point (1301) to files in various external repositories like Media and Metadata Files (1302), Identity Providers (1303), Contract Repositories (1304), and Identifier Providers (1305).

Let's look in detail at how the external repositories, the references to them and the Distributed Ledger (1300) work together. For purposes of explanation and not-limitation, we may treat the Distributed Ledger (1300) as a single entity. There may be typically multiple, often many copies of the Distributed Ledger (1300). In fact, the files that we point to can also be distributed and/or replicated across multiple servers.

### Ecosystem Examples

By way of example, let's follow some Creative Works through their life cycles. These non-limiting examples should be sufficient to make clear how the system works, and we will assume that once the system is understood for some business environments, it can be applied to others.

### Ecosystem Example—Music

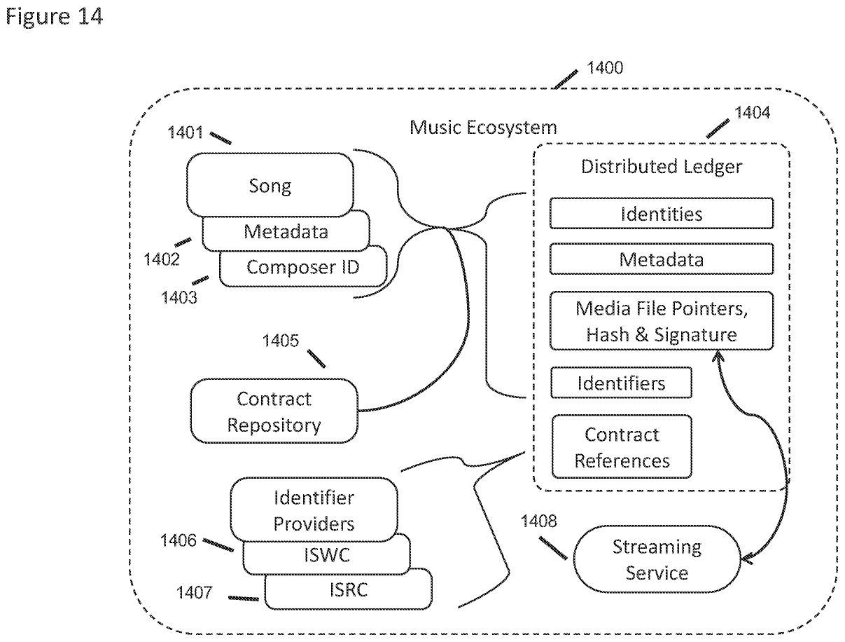

Some components of the music example are shown in FIG. 14. Let's suppose that I am a songwriter. And I have written a song (1401). I use software that takes the recording of the song and adds some metadata (1402) into a composite file for example using ID3 tags. Among the metadata I have added is my name as a composer including a link to my Identity (1403)—perhaps using Self Sovereign Identity or another form of Distributed Identity where the credentials are verified using Public-key cryptography anchored on a distributed ledger. There are many other types of metadata that I can add but for the purpose of this exercise, the most important component is the Composer ID (1403). Now, this compound audio file may be hashed and signed, and that hash and signature may be placed in an immutable record in the Distributed Ledger (1404) such as a blockchain. This record may be timestamped and the address of that blockchain entry may be returned to the songwriter (or their representative). This record can be used to determine that the hash of the song was placed in the record at a specific time and so can be used to prove that a recording was uploaded by the identified person at a time and date.

Now let's suppose that I change the song (1401)—say add a bridge. Now I can hash and sign the new version of the song and add it to the ledger. There is now a record of both the original composition and the updated composition and their dates of registration in the Distributed Ledger (1404).

Next, let's suppose that I have continued work on the song with a co-writer and we have agreed on the shares of ownership of the copyright of the song and have created and stored an electronic contract in a Contract Repository (1405) stipulating that relationship. That contract can be hashed and signed and placed in its own Distributed Ledger (1404) and that ledger address can be added to the ledger for the song or the hash and signature of the contract itself can be added to the ledger. Note that although the diagram shows the Distributed Ledger (1404) as a single item, it may be distributed and there can be many different ledgers (each also distributed) that point to each other. Now whenever someone finds the song, say using the ISWC, it can reference the identities of the songwriters and the contract stipulating the rights associated with the song.

Continuing with this chain of handling and control, suppose a recording artist records the song. That recording can have its own hash and signature which can be added to the distributed ledger of the song and the song data can be added to the distributed ledger of the recording.

Now, let's presume I have registered the song and received an ISWC (1406), issued by CISAC, the International Confederation of Societies of Authors and Composers, which may be used by streaming services to pay my representatives for the use of my song. I can add the ISWC to my Ledger and now the ISWC may be immutably bound to that record of my composition. Now, if I want to authorize a use for that work, say to a recording artist, I can just send a link and give access to the file. Now if the Recording artist makes a recording, they can store the recording and hash and sign it and put that in their own blockchain ledger and point back to the ledger of the song. The recording artist may then get an identifier called an ISRC (1407). They can add the ISRC (1407) to their immutable ledger which references the ledger associated with the song and can also include the ISWC. If the recording artist then sends their song to a music streaming service (1408), they can send a link to the entry in the ledger and the streaming service can acquire the song and have access to the whole chain of handling and control and can pay all the parties in the chain as required by agreement or by statute. The same basic architecture may work for other industries.

Ecosystem Example—Photography

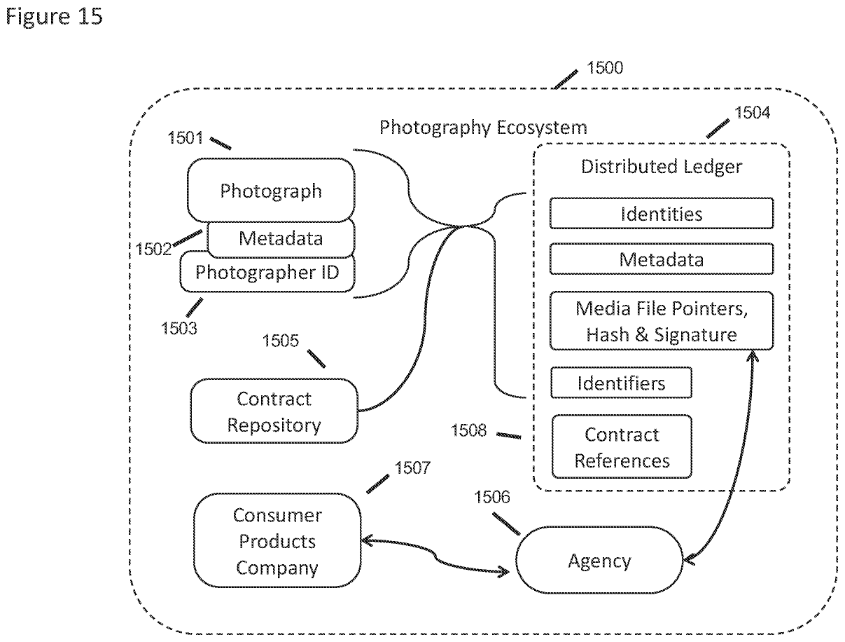

Let's look next at professional photography as shown in FIG. 15. Professional photographers often receive payment from brands that want photos for advertisements. These agreements are often negotiated by Ad Agencies (1506) that connect the brands with the photographers. Typically, the agreements are kept separated from the photographs. Let us apply a similar technology architecture to the professional photography business. For example, a consumer products company (1507) wants some photos for an ad campaign. They contact their Ad Agency (1506) who contacts a photographer, that may be associated with a unique ID (1503), to generate photographs (1501) and who agrees to do the photo shoot and give the consumer products company the rights to use the photographs for 3 years in North America. A contract may be negotiated by the Ad Agency (1506) and put in a Contract Repository (1505, perhaps distributed, perhaps under the control of the Ad Agency (1506) or of the photographer). The agreement may be signed by the parties—perhaps the consumer brand, the Ad Agency (1506), and the photographer. This agreement may be hashed and digitally signed. The agreement may have a schedule that references the photographs (1501) that can be used. The links to the agreement and the photographs may be stored in the Distributed Ledger (1504) and are placed in the Metadata (1502) of the photographs (1501).

Now suppose I am at the consumer brand (1507) and I am looking for a photograph to use in a campaign in Asia. I browse the photographs that we have used before and I see a photograph (1501) created above in our example. Embedded in that photograph may be a link to the agreement (1508) that governs the use of the photograph (1501). I follow the link and learn that we do not have rights to use the photo in Asia. I send the link to the photo (which includes the link to the agreement) to the Ad Agency (1506). They may look at the agreement and negotiate an extension of rights for their photographer, parties sign the agreement, and it may be hashed and digitally signed and added to the ledger and the brand uses the photo in their campaign.

To reiterate, though these are just examples, people familiar with an industry can apply this approach and architecture broadly to their industry. Let me demonstrate further with two more non-limiting examples.

### Ecosystem Example—Movies and TV

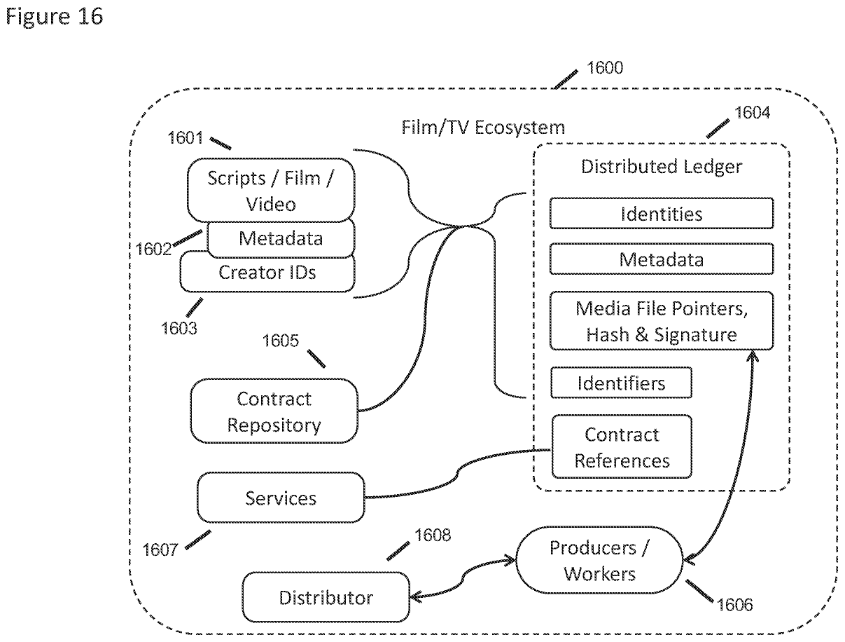

An non-limiting example architecture for the Television and Movie Production industry can be seen in FIG. 16. Traditionally movies and TV shows are packaged by agents or producers who put together the entities who work on the films or TV shows. The production process may include relationships among many entities often including producers, directors, actors, agents, directors of photography, camera operators, casting directors, lighting directors, assistant directors, grips, and many others. Some may be paid for time spent (daily, hourly, etc.) others may be paid as a part of the eventual revenue generated by the work (royalties or back-end). Coordinating this is very expensive and time consuming. In today's world, amateurs are making film and video properties but may not have access to the deep resources of the studios and networks.

Using embodiments of the systems and methods described herein, many of the services previously provided by the major studios can now be provided virtually—kind of like a studio as a service. Let us drill down on an example of a film production. Suppose I have an idea for a movie and have written a script (1601) that may be associated with metadata 1602 and/or one or more Creator IDs (1603). I can store the script in the cloud and copyright is with hashes and signatures in the Distributed Ledger (1604) just as I did in the music example above. Now I can send a link and share the script with a movie producer (1606) who likes it, and we sign an agreement included in a Contract Repository (1605) stipulating my share of final revenue, length of the option, etc. This is now referenced in the Distributed Ledger (1604) for the proposed film. The producer now negotiates with other parties (1606) to work on the film, say a financier who agrees to pay for the production, then a director who agrees to do the film—agreements in the Contract Repository (1605) are added to the Distributed Ledgers (1604). The director contacts other workers (1606) like actors, a director of photography, camera operators, casting directors, grips, etc. Everyone signs an agreement of one kind or another included in the Contract Repository (1605)—hourly (below-the-line) workers accept a simple click license, entities that participate in the profits (above-the-line) have more complex agreements. Now that we have assembled a team, production can begin.

There are many services (1607) that can be provided (more about this is discussed in the Services section below). For example, automatic timecards facilitated by mobile phone apps that track proximity to the set. Services for doing Visual Effects, storage of Dailies (footage from each day), salary processing for below-the-line workers, etc. The media can be stored in the media repository with hashes and signatures attesting to the date, time, camera operator, script version, lighting, location, etc. The services can have automatic contracts stored in the media repository and attested to by contracts, hashes, and digital signatures. Versions of the film in progress can be shared with people with the appropriate credentials. When it is time to distribute the film, links can be sent to distributors (1608) and from there to theaters and streaming services—all governed by the electronic contracts referenced in the Distributed Ledger (1604).

### Ecosystem Example—Journalism

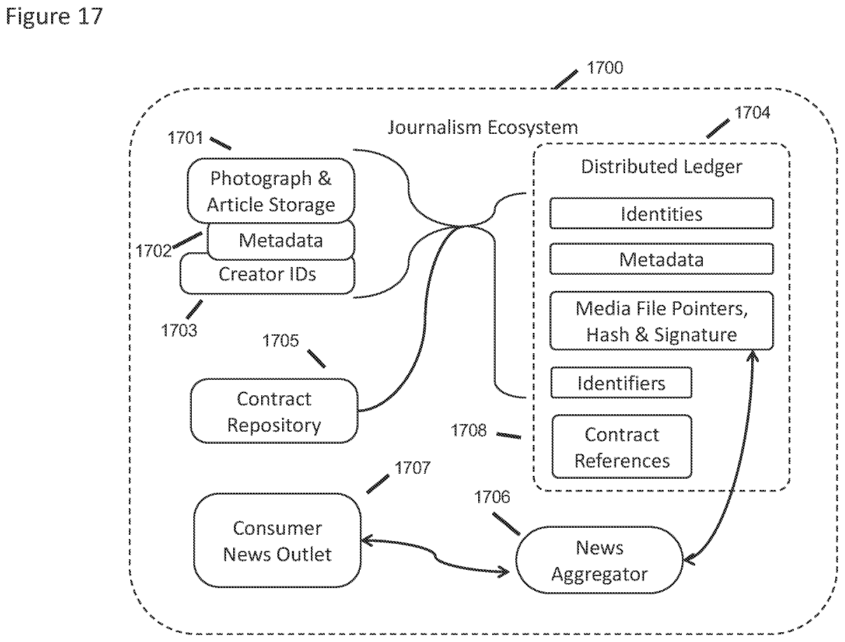

A further non-limiting example, as can be seen in FIG. 17, is in the field of journalism. Journalism is an industry in flux. Historically journalists and photographers worked for a newspaper or magazine or a news service, they were on salary and their work was presented through the newspaper or magazine. Today, many articles are syndicated—either with or mostly without—explicit permission of the news gathering organization or the journalists themselves often to services like the browser pages of search engine companies or social networking companies.

This disclosure imagines a world where there can be a free flow of information from professional and amateur journalists or indeed anyone with the ability to write or photograph or video any event or opinion. Imagine you a journalist and you are there when there is a coup by the people of a small Eastern European country. You capture incredible photos and your friend who is a journalist and is fluent in English describes it in gripping detail. In a universe enabled by the technology in this disclosure, you may store the photos and the article (1701) in the storage component of the Cloud System (1700), you may add the byline in metadata (1702) and author identity information to the file (1703), and a short agreement may be included in a Contract Repository (1705) where the two of you agree that you will split any remuneration. This may then be shared with a News Aggregator or Distribution Network (1706) where various news gathering entities, some using artificial intelligence, see the article and bid on the right to distribute the article. You choose the distributor with the policy you like (e.g., say a small advance and a payment based on number of views) and digitally sign the agreement and the article shows in my news feed minutes after it occurred.

Again, the basic principles associated with this disclosure are that anyone can create a Creative Work, share it in an open marketplace and control and be remunerated for its consumption as defined by statute or agreement.

Services

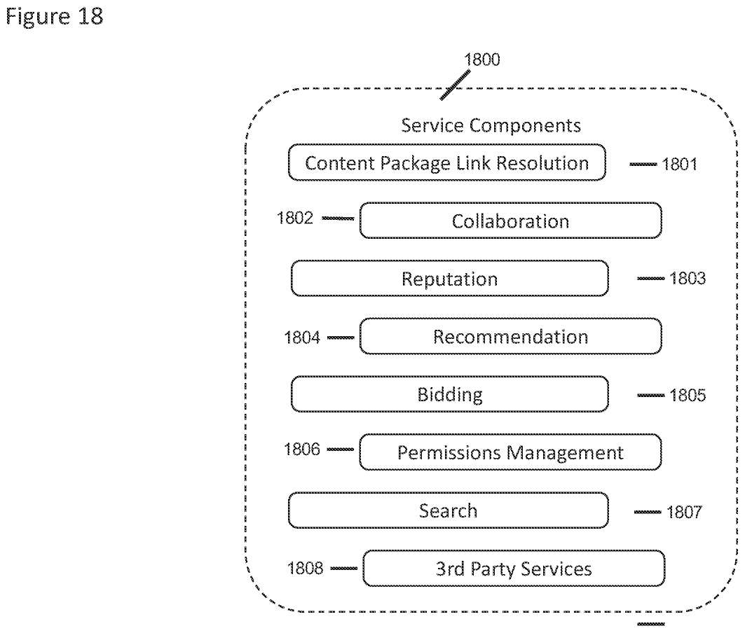

What follows is a detailed breakdown of the Service Components. As can be seen in FIG. 18, there may be a multitude of possible services that a cloud-based system like the one described here can provide. The elements that comprise the Service Components (1800) may be the CPL Resolution (1801), Collaboration (1802), Reputation (1803), Recommendation (1804), Bidding (1805), Permissions Management (1806), Search (1807), and/or Third Party Services (1808). Services may be provided to individual Content Ecosystems or across multiple ecosystems. For example, one might look for a text string only within scripts they have written or across all the scripts in the ecosystem (subject to permissions) or one might look for a text string across scripts, newspaper articles or song lyrics. The individual services are described in more detail below.

Provisioning of Content Package Links

CPLs may be the connective tissue that holds together certain elements of the system and that allow for the resolution of content to the participants in the value chain. In some embodiments, they may be like URLs on the Internet except that are smart and/or governed. A composer may be associated with the songs they have written, the contracts they have signed, the publishers and Performance Rights Organizations they have deals with, the recording artists who have performed their songs and the distributors who have distributed them. Sending a CPL to an entity may assure that, if they have sufficient permissions, they can access the current and accurate data. To say it another way, content and associated rights and obligations can be easily referenced and can be accessed by those with the proper permissions.

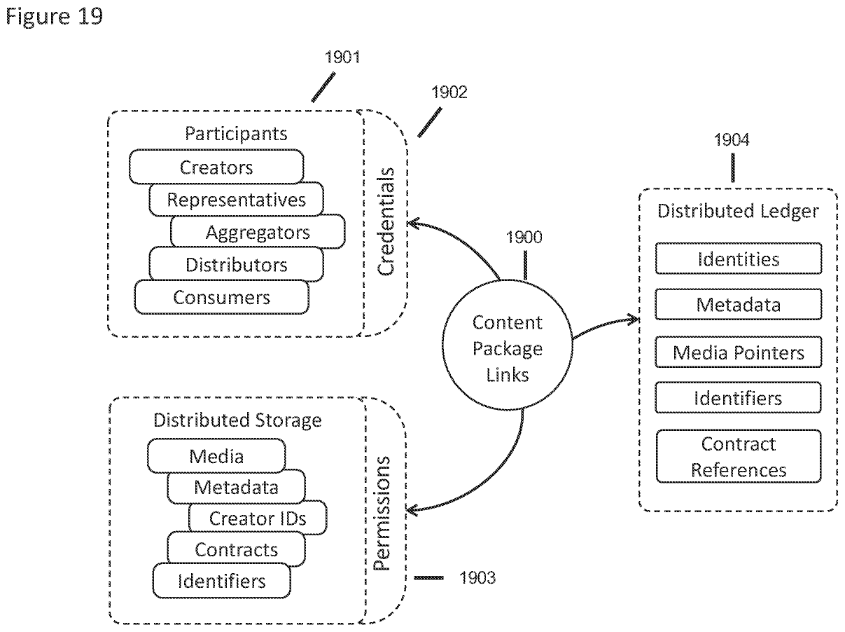

Elements can be linked to associated elements. Looking at FIG. 19, we can describe in some detail as to how the CPLs (1900) work. First you have the Participants in the System (1901). These participants include the Creators and their Representatives (managers, agents, lawyers, etc.), content Aggregators, content Distributors, and Consumers. They may be credentialed (1902). The credentials can be as robust as security requires—from open access (no credentials required) all the way to credentials issued by robust credentialling agencies requiring physical factors and in person meeting. Creators create Media Content and associated Metadata and connect them to their Identities and Media Identifiers and any associated Contracts (e.g., Agreements) which may be stored in Distributed Storage (1903). As described further in this disclosure, the content in the Distributed Storage (1903) may be hashed and signed so that it can be confirmed that the content has not been tampered with. These hashes and signatures may be stored in an Immutable Ledger (1904), which may be distributed. This Ledger (1904) may contain CPLs (1900) that link to the Distributed Storage (1903), however access is controlled—again as robustly as required, by a Permissions Management module which may control access based on credential presented.

Media elements (including the Contracts, identifiers, etc.) can be virtualized so that the relationships among the various elements can be dynamically updated. As described above, this means that additional elements like standardized identifiers can be bound after the fact to the original elements. This also means that different versions of content can have different agreements associated with them and agreements can supersede previous agreements. To explain by a non-limiting example: suppose I have a graphic that I have licensed to an advertiser for use in North America. Now suppose that advertiser wants to use that graphic in Europe. That graphic may be stored in the Distributed Storage (1903). Associated with that graphic may be a contract which stipulates the rights associated with it as between the advertiser and the graphic creator. This graphic and the related contract may be bound together in the following way: the graphic and its CPL may be hashed and signed, contract and its CPL may be hashed and signed, the graphic CPL and the contract CPL together may be hashed and signed.

When the agency representative is logged in to the Agencies system, they may be given credentials. The credentials may be associated with their role at the agency, let's assume for this example that they have the rights to see the graphics and the contract (or more likely a short abstract of the contract explaining the rights the agency has). They may pull up the graphic in their directory, probably by searching on the campaign associated with the graphics. To them, it is just like searching and viewing a directory—the permission granting is invisible, however, they may see in the directory, those graphics, and agreements which they have permission to view. So, browsing the graphics in the directory they may see the graphics from the old campaign used in North America.

When they select the graphic, they may be selecting a CPL which points to the entry in the Distributed Ledger. That CPL may bring up a list of elements associated with the CPL. If this were a song, it might bring up the composer, the publisher, the ISWC, the Performing Rights Organization and a list of ISRCs and their associated artists, record labels and legal representatives. In this case, the list of elements may be the name of the graphic artist and a link to the contract (and abstract of the contract), the legal representatives, and their location in the Distributed Storage.

Now when the agency representative views the abstract of the agreement, they may see that the rights do not include rights for Europe. They may select “modify rights” as a choice associated with the agreement and then select “territory of use” and from there select “add Europe.” This may generate a new agreement and stores the agreement in the Distributed Storage, creating a CPL which is then appended to the CPL for the original contract in the Distributed Ledger. The agency representative may now send the new CPL to the graphic designer's representative who resolves the CPL, looks at the new contract, shares it with the graphic designer who looks at the agreement and approves.

The agreement may now be signed and routed back to the agency representative who routes it to the correct party internally who signs it. Now this new signed agreement may be hashed and digitally signed and written to the Distributed Ledger as an addendum to the original agreement. Now, when the agency representative looks at the graphic, the CPL which points to the original graphic includes the CPL to the new contract and the abstract brought up by following that CPL states that the graphic may be used in Europe and the campaign can proceed with the appropriate remuneration flowing back to the graphic artist.

CPLs may point to the aggregation of the data associated with any Creative Work filtered through the lens of access permissions.

Collaboration Services

Creatives often work together in pairs and groups of all sizes. In music, songs are often written by 2, 3, 5 or even 10 writers. In films, there is even more collaboration between the original writer or writers, the producer, the director, the director of photography, the actors, the editors, studio executives, and others. In journalism there is collaboration between the journalist, the photographer, and the editor and perhaps the news service that may want to extract parts of the story. Because there are many kinds of collaborators, there are many kinds of collaborations that may be supported by the system.

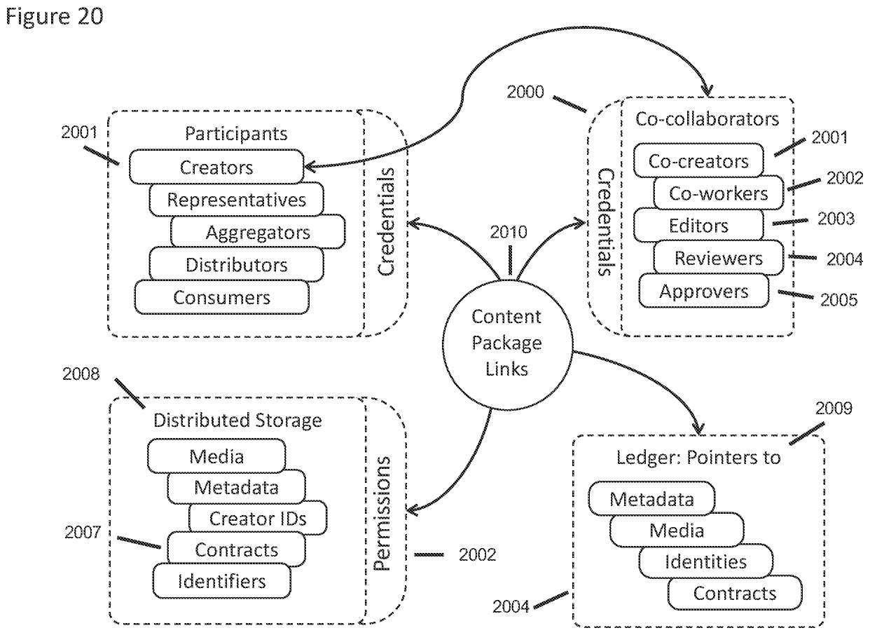

FIG. 20 shows a non-limiting example of the relationship among participants of the System and the connectivity of CPLs 2010 as it might apply to the Film or TV ecosystem consistent with certain embodiments disclosed herein. For purposes of abstraction, we have arbitrarily broken the Co-collaborators (2000) into non-limiting buckets with the following rough definitions (knowing that the groupings are arbitrary, and any labeled function can have any access depending on permissions):
Creators and Co-creators (2001) may be the people, entities or Artificial Intelligence Systems that create the original work. These may include photographers, writers, composers, etc.
Co-workers (2002) may be the people who work to fulfill the original creative vision. These may include camera operators, assistants, fact checkers, hired musicians, etc.
Editors (2003) may be the people who have the permissions and ability to modify the work—typically in coordination with creators in service of the final work.
Reviewers (2004) may be people who look at the final or near final product and determine the suitability for release, sending it back to the Editors and Creators if necessary.
Approvers (2005) may be the people that facilitate the final release to distributors, negotiating distribution agreements giving final approval for release.

People working in the creative fields often perform multiple roles. For example, a photographer might be Creators, the Co-worker, the Editor, the Reviewer, and the Approver all in one. Though a film production might have hundreds of workers performing different functions, the Director might perform multiple roles (in fact, a single person might have multiple roles listed in the credits). Additionally, the names mean different things in different marketplaces. For example, an editor in film performs a different function than a magazine editor. However, for the purposes of this disclosure, the names represent relationships to the development of a creative work and one practiced in the art should be able to apply to the specifics of their use.

To demonstrate Collaboration Services, a good example to start with—because it is historically the most collaborative and complex, is film (examples of which are illustrated in FIGS. 20 & 21). The process of filmmaking usually starts with a script or at least an idea for a script by a Creator (2101). Sometimes there are multiple writers creating an original script, sometimes writers are hired by a Producer to create a script and sometimes, even after filming has started, other writers are added to work on the script. For the purposes of this example, let's call the Producer of the film, who hires the writers, an Approver (2102). The Approver may have the right to approve the final script or not. They may be responsible for raising money to fund the production and they may have approval rights to the hiring of key actors, the Director, and the Director of Photography. These may be stipulated in contracts (2007, 2103) which may be stored in the Distributed Storage (2008, 2103) and are referenced by CPLs (2010, 2103) in the Ledger (2009, 2103). Now that we have established some of the Participants and their roles, let's examine how the system may work in a film production.

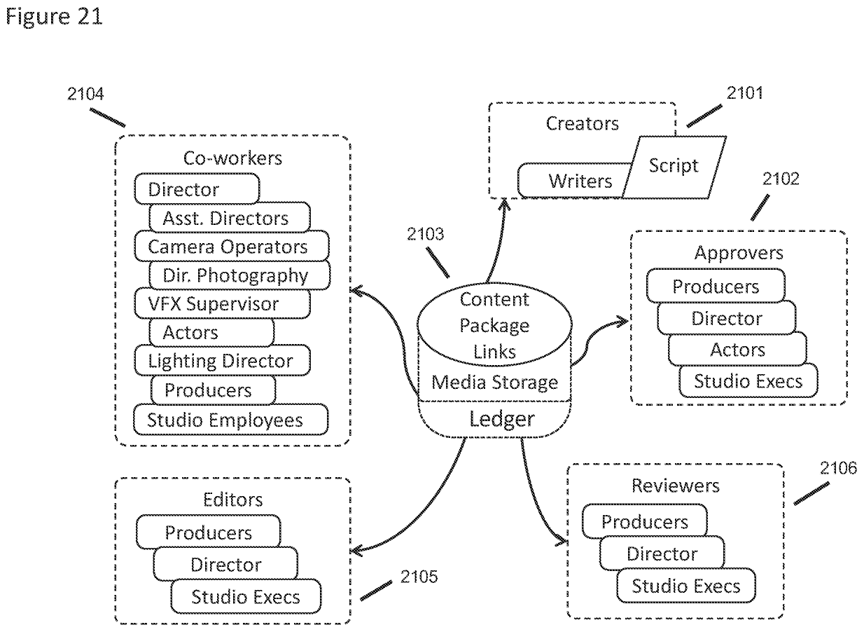

Looking at FIG. 21, we start with a script (2101). The script may be sent to a Producer or a Studio Executive (2102). In our universe, the script has been stored in the Media Storage, has been hashed and signed and written to the Distributed Ledger and may sent to others in the system using CPLs (2103). We may use a similar mechanism throughout the process, which may be referred to herein in certain instances as being Stored, Signed and Linked or (“SSLed”). So, the script has been SSLed and sent to a Producer or a Studio Executive (2102). Typically, the Producer or Studio Executive (2102) raises money either through internally budgeting or external funding. Sometimes others like well-known actors or Directors are “attached” to raise the money. Once the original Approvers (2102) are in alignment, Contracts are written and SSLed to all the parties. Now, the Producers and the Director begin populating the project with Co-workers (2104). Some of these are “above-the-line” that is they receive a share of the profits as well as potentially a salary or an advance against future royalties and some are “below-the-line,” that is they receive salary only. Some of the co-workers receive contracts, other just OK click licenses. Some have been SSLed the script others have been contacted by more senior Co-Workers (2104). Nonetheless, the agreements have been SSLed to the Producers and/or the appropriate production or studio employees. Now (after location scouting, more casting, and many detailed production decisions have been made), acting and filming can begin in earnest. When workers show up on location, they can be tracked automatically using location services provided to an application on their phones so that they can be paid automatically using one or more payment services. Their “timecards” are SSLed to the “Contract Engine” which know how much and under what circumstances to pay the Co-workers (2104) and that is SSLed to a Payment Service that pays the contractually defined amount in the contractually defined period.

As film is shot, it may be SSLed to a repository of footage where it can be viewed by Editors (2105). Comments can be added and SSLed to other Editors (2105) or Co-workers (2104) as necessary. This process may continue until the Editors (2105) believe the film is completed. The film may be SSLed to the Reviewers (2106) who may approve it or suggest changes. In the film universe, Editors (2105), Reviewers (2106) and Approvers (2102) are often many or even all the same people, but the distinctions are good to keep in the architecture because (a) other industries have different roles in these processes and (b) from a functional and permission granting perspective, it is useful.

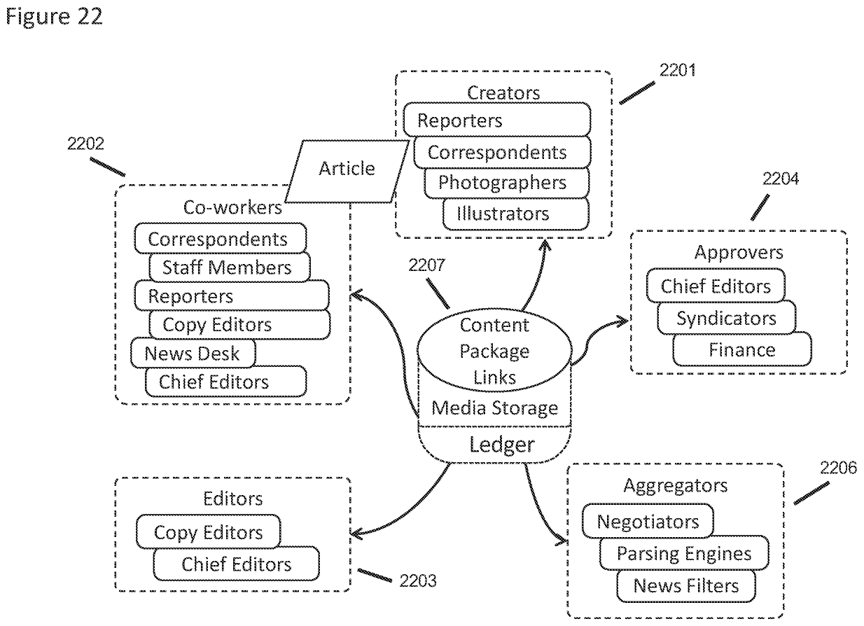

Now, let us map these domains to other industries starting with Journalism as shown in FIG. 22.

In our universe, just as in traditional news organizations, correspondents (2201) report news from where they are located, typically electronically. However, in our universe, media may be SSLed during various steps of the process. Breaking stories may be written by staff members (2202), using information collected by reporters (2201) in the field. Radio and television reporters often report “live” from the scene. Commentators or columnists (2202) may interpret the news and offer interpretation, opinion, or analysis.

Reporters (2201) may take notes and/or take photographs or shoot videos, Material is organized, and the focus or emphasis is determined, and the stories are written. The story is then edited by news or copyeditors (2203), who function from the news desk (2202, 2203). The headline of the story may be typically decided by the news desk. The news desk also re-writes or changes the style and tone. Note that even within one section like the Co-workers (2202) internal communications may be SSLed. Next, the chief editor approves the content (2203). Finally, a collection of stories is laid out on dummy pages, then final review by the editor (2204) and it is sent for publishing. The writer's byline has been attached from the beginning just as the identities of all the co-workers have been attached. This enables a couple of possibilities: 1) in the event there are questions after the fact, forensic analysis is easily performed and 2) if new business models pay workers for their work based on consumption, the data is available. In fact mechanisms based on contributions can be automatically embedded in electronic contracts in the Media Storage (2207) and payments can be automated.

The news universe may include aggregators (2206). There are news agencies that gather news and distribute it to local outlets who typically do not have international reporters. Now there are further paths as there are countless “Citizen Journalists”—people who are in the right place at the right time with a camera phone or travelers who write about their travels or bloggers who typically comment on life. There is a multiplicity of news aggregators like Browser companies and social networks that can distribute news from professional news organizations as well as from Citizen Journalists. Based on the architecture in this disclosure, payments can be made to journalists and news organizations defined by contractual agreements using any number of different mechanisms. For example, Journalists could be paid based on number of views or based on a monthly exclusive arrangement or salaried for their full output. The architecture can support arbitrarily complex models because the participants and the paths and their identities and identifiers may be maintained in an Immutable Ledger.

Multimedia Collaboration

When Creatives work together, they may use many tools. They may exchange scripts, parts of songs article ideas, photographs, etc. Collaboration environments are often local and ephemeral. By local, we mean that people are in the same place writing on a whiteboard or looking at printed photos or presentations on a projected screen. Many of these working sessions are also ephemeral. Maybe someone takes a photo of the whiteboard or writes notes that they share afterword, but the creative process mostly happens in person. With current technology, there is no reason the sessions cannot occur virtually with all interactions recorded, stored, and copyrighted and accessible after with all the participants noted and all actions recorded.

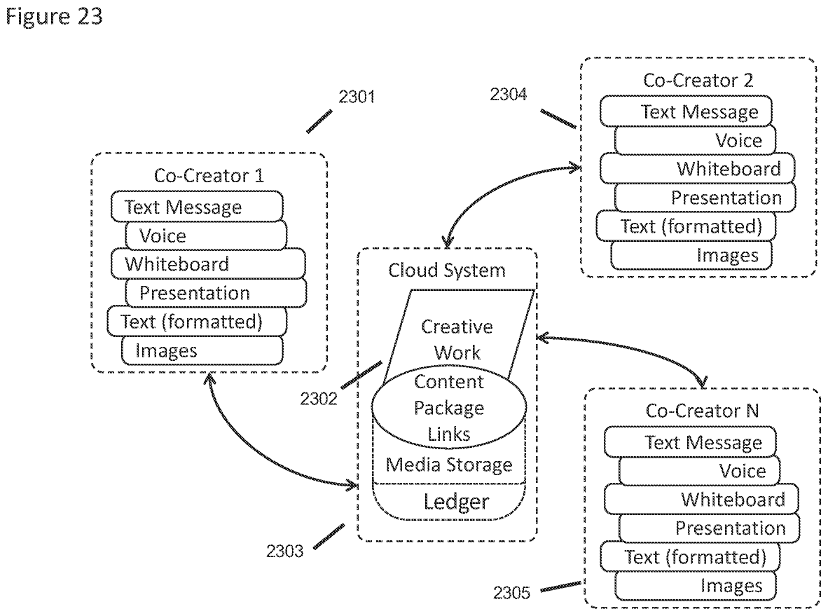

Looking at FIG. 23, we start with a Creator—Co-Creator (2301) who begins with a Work in progress—a song, a script, a video, etc. Their Creative Work (2302) may be stored in the CS (2303). Now the Creator (2301) wants to share with other Co-Creators (2304, 2305). CPLs may be shared using any collaborative technology, including, but not limited to voice, text, dynamic whiteboarding and sharing documents such as formatted text, presentations, graphics, and videos. These collaborative documents and communications can be stored in the CS (2303) and the whole session can be replayed and can also be copyrighted with the session hashed and signed and the references placed on the ledger. So, for example, I could ask, “What was that idea you had yesterday just before we broke for lunch?” and we would be able to replay the session to find out. Also, when copyright and provenance come into question, the record can be checked—everything is available for forensic analysis. Using Artificial Intelligence, mechanisms can be developed to determine ownership of the creation based on analysis of contributions of individuals. Creatives do not like to talk about who owns how much of what because it can be uncomfortable. If the system tracks the input from all the participants, it can determine ownership of the copyrights automatically.

Bidding

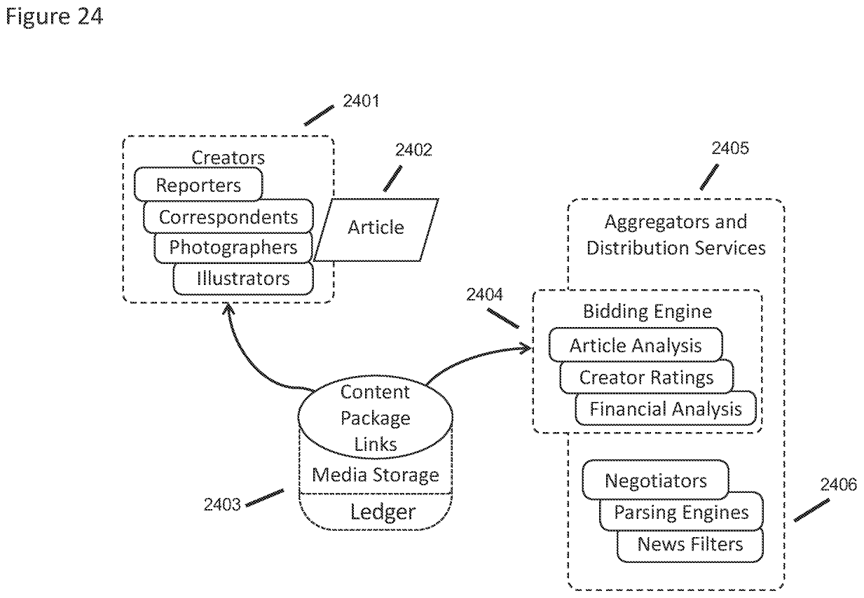

One form of distribution agreement is Bidding. As shown in FIG. 24, a system of bidding can also be built. Let us presume that one or more Creators (2401) have created an Article (2402). CPLs (2403) may be SSLed to a Bidding Engine (2404) either provided as a service to or hosted by Aggregators or Distribution Services (2405) who use their Negotiators (e.g., people or machines), Parsing Engines, and/or News Filters (2406) to determine the proposed value. A simple mechanism might be to ascribe a value per view of at least x number of seconds or minutes based on the reputation or past success of the journalist. Perhaps a machine analysis of the article as one factor combined with the journalist reputation (see Reputation Services below) and combined with the “hotness” of the topic.

Reputation Services

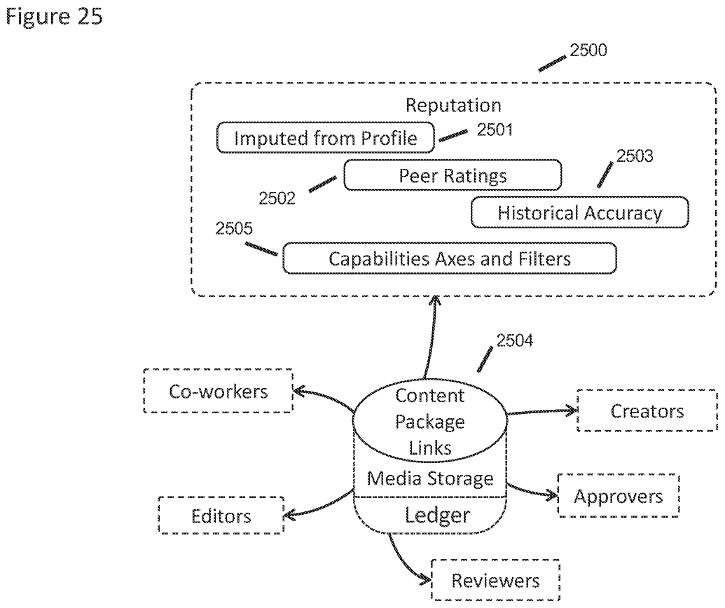

Reputation Services may be useful for determining the applicability of hiring people, reviewing their abilities, their Creative Works, or their opinions of the Works of others. As can be seen in FIG. 25, Reputation (2500) may be determined using analysis across several axes. One axis is their imputed reputation, which in certain embodiments may be based on their credits and biography (2501). The second axis may be based on Peer Ratings (2502)—input from other participants in the ecosystem considering the weighting of the value of the input of the various participants based on their credibility as applied to the judgment at hand. The third axis may be the historical accuracy (2503) of their analysis of other participants and Creative Works. As with the other services, they may be provided by storing, binding, and referencing the creative elements themselves, the identifiers of those elements and the creators and collaborators of those elements using CPLs (2504).

Reputation services may add an additional layer to the information about the creators, the collaborators, and their creations. If one is looking for a creator or a collaborator, it is useful to know their abilities. Their abilities may be different on different axes and these are separated based on looking at the axes of the capabilities and filtering (2505) out those measures that are less relevant. Looking at these four non-limiting example components of reputation individually, we have:

1. Imputed from Profile (2501): There can be assumptions made about the capabilities of the various participants in our ecosystem based on their background. Some examples: A Director of Photography is probably a good judge of the quality of the camerawork or lighting in a film. A drummer is probably a good judge of the rhythm of a recording. An experienced editor at a major newspaper is probably a pretty good judge of the veracity of a news source. Axes of imputed capability can be applied as the first axis of a creator's reputation.

2. Peer Ratings (2502): Additionally, the rating of an individual participant can be made more robust by considering the opinions of others in the network. So, just as with other social networks if most commentors think that a script is rated 10 out of 10, the odds of that script being pretty good are high and the inverse may also be true. However, this is only the first step in this axis of the ratings system. We can weigh the ratings of the reviewers. So, if we are rating a camera operator, we have the opinions of others in the system about that camera operator, but we would weight the opinions of a Director of Photography more heavily than say a Location Scout.

2. Historical Accuracy (2503): The third axis of ratings weighting is historical accuracy. We can look at people's ratings in the past and see how accurate they were and weight the opinions of those with more historical accuracy, higher. To clarify by way of example: suppose we are interested in finding the next big comedian. We would look through our records and see which comedians became popular and when they became popular. Now we would look at the people who were rating them highly 3 months before they became popular. This group of “Comedy Raters” would be our bell weather group and we would look at the unknown comics they are currently rated highly by our Comedy Raters in anticipation that they might be popular 3 months from now. This can work across all fields and all participants. For example, if a group of journalists had accurately predicted price fluctuations in the Ruble, we might rate their opinion on Ruble exchange rates more highly than others.

4. Capabilities Axes and Filters (2505): What is left to do is to take the three elements above (Imputed from Profile (2501), Peer Ratings (2502), and Historical Accuracy (2503)) and put them together into a ratings matrix for individual Creators and Co-creators within a particular set of requirements. So, if we are looking to hire a camera operator, we may use multiple axes to determine a reputation score regarding that capability. Of course, one Creator might be highly rated, for example on script writing but not well rated on writing song lyrics.

Recommendation Services

Recommendation Services may be provided as a window into or corollary to—almost the inverse of Reputation Services. As noted briefly above the Capabilities Axes and Filters (2505) may be how we tailor the reputation analysis regarding specific capabilities. Conversely, if we are looking for Creators or their Works, we can use the Filters to optimize for those Creators or Works that fit with our needs like the comedian search example above. This can be used to assemble complete teams, to find potentially good songs for a recording artist, to find good journalists to hire or weigh the probable accuracy of a story, to find a promising new novelist or poet or a great up and coming photographer, and/or the like.

Permissions Management

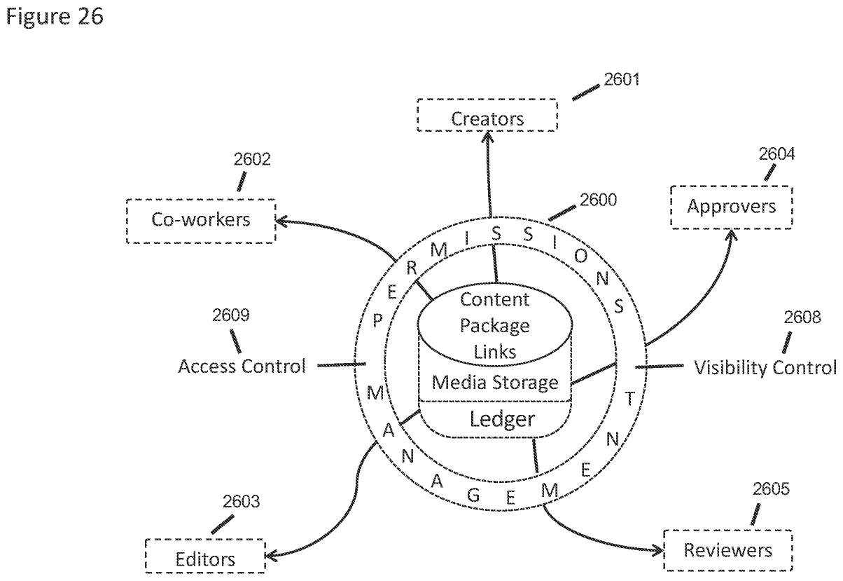

As noted above, Creators and their representatives may be able to control who can view or listen to their Creative works and when they can. Looking at FIG. 26, we can see a Permissions Management (2600) system the persons or entities may use to provide permissions to the various other entities in the system. We begin with a User. A User can be a Creator (2601), a Co-worker (2602), an Editor (2603), a Reviewer (2605) or an Approver (2604). A User may represent the actual individual or entity that participates in the system using their real name and may be represented by a User Account. Users may also interact in the system using different Persona (e.g., Display Names or Aliases) to maintain levels of privacy and/or anonymity. Users can control the visibility of their Display Names and of the public facing elements associated with each Persona and modify the information related to and/or displayed (like profile elements) in association with each Persona. Users can switch between Personae. Access to (2609) and Visibility of (2608) Creative Works may be controlled by Permissions (2600).

Permissions can be allocated to individual Users, Personae, or Groups. A Group may be a set of Personas that allow operations to be performed for the entire group such as giving visibility, sending messages, etc. Groups can be created by an Entity and may be visible to Entities that have been invited to join the group. Groups can be used for controlling access to titles or sending messages to all entities in a group. For example, if I am working on a film, I might have a group of all the people working on the film and a group of people with editorial responsibility. If I am a journalist, I might have a group that includes the News Desk, Copy Editors, and the Chief Editor. If I am a student at a Music University, I might have one group that is all the students in the university and one that is the members of my ensemble and one that is members of my harmony class.

The system also may have Visibility Rules. Visibility Rules may provide a mechanism of specifying the visibility (2608) of items to other users of the system. For example, as in the music example above, I might share some things with only my band mates and other things with everyone in the university. The system may support very granular visibility rules. The visibility can be broken down by inclusions or exclusion. Inclusion examples may be visible to all, visible to one or more specific entities, and/or visible to all entities in a specific group. Examples of exclusions may be excluding all, meaning the Item is only visible to the Entity, and/or that the item is not visible to a specified entity or the item is not visible to any entity in a specified group.

Multiple visibility rules can be specified. Inclusions and Exclusions may be evaluated together. The exclusions may remove visibility, Exclusions may override Inclusions, but the reverse is also possible.

Groups can be used for controlling access to titles or sending messages to entities in a group. Entities can communicate using text or audio with other Entities in the system via messaging to their Display Name allowing one to send messages for example, to one group, from one Persona and to another group from a different Persona.

The owner of a Title can provide access rights to other Entities and or Groups including the right to consume (e.g., listen to or view), a Title or Artifact, and or the right to update or edit a Title or Artifact (e.g., including change title/metadata, add new version, register it, etc.)

Internet search has evolved over the years and it has been bent to the purpose of generating revenue based on selling ads. Search mechanisms consistent with various aspects of the disclosed embodiments may be designed to give Creatives and those in search of Creative Works the tools to find the content that is right for their purpose, not necessarily the purpose of a vendor or advertiser. Consequently, an intuitive yet powerful user interface that improves search capabilities for the searcher may be used.

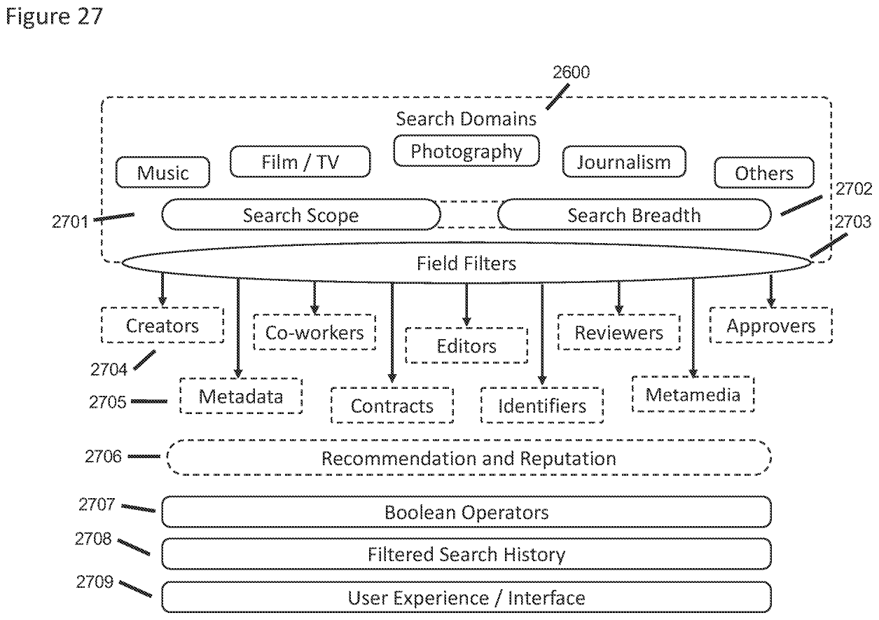

As can be seen in FIG. 27, the Search interface may be laid out as follows: There may be separate search domains (2600) for the various media domains such as Music, Film & TV, Photography, Journalism, etc. The Scope (2701) of the Searches can be within one domain or across multiple domains simultaneously so that if you are looking for someone who is both a Photographer and a Videographer, that can define the Scope of the search. One could search across all domains, but it is probable that more targeted searches will be more effective. Another axis of Search is the Breadth. The Breadth (2702) defines how wide your search is. Are you searching through your own Creative Works, through the Creative works within your company, or broadly across all content of a media type?

The next layer of Filtering may be referred to as Field Filters (2703). These may be broken into to general domains. The first are the people or entities that make, approve, or review the Creative Works (2704) including, for example and without limitation, one or more of Creators, Co-workers, Editors, Reviewers, and/or or Approvers. The other group of Field Filters (2703) are the various Metadata (2705) including, for example and without limitation, one or more of Metadata, Contracts, Identifiers and/or Meta-descriptors.

One of the more valuable Search Filters/Optimizers is using the Recommendation and Reputation engines (2706) defined above. In this way, content can be found with the appropriate applicability/quality based on the recommendation/reputation axes described above. For example, you might want only camera operators with rating of 4 or above as rated by Directors of Photography or songs that are highly rated by drummers because you are looking for great grooves.

In combination with all these filters, Boolean Operators (2707) may integrate the various filters in combination. The supported Boolean Operators (2707) may include, for example and without limitation, one or more of:
OR: Either term (or both) will be in the returned document. (Broadens the search)
Quotes: Quotation marks are used when you are searching for a specific word combination or an exact phrase.
AND: Requires both terms to be in each item returned. If one term is contained in the document and the other is not, the item is not included in the resulting list. (Narrows the search)
NOT: The first term is searched, then any records containing the term after the operator is subtracted from the results
Parentheses: Deal with search statements within the parentheses first, then apply any statements that are not enclosed.

Boolean Operators may be applied to the current text in a field within the context of a Domain. If you are looking for Songs or Songwriters, the search may be in that domain. If you are searching for Journalists, the field may be in that Domain and likewise for Film, Photography, etc. Within Domains there may be other filters so if you are searching in music, you can look for titles or lyrics or tempo markings or writers. You can also search on Mood or Genre. If you are in film the choices would be similarly relevant (e.g., Camera Operators, Directors, Text in scripts, date filmed, etc.). The basic principle is that, based on the domain of the User expectations, the appropriate fields may be available, and the default Boolean behaviors may be appropriate.

The interface may provide the ability to go backwards and forwards through the Search History (2708) showing the results, not just the queries. One can also search within previous searches and perform meta searches within the search results. For example, yesterday you searched for highly rated Camera Operators and today you want to rank them based on having worked with a select set of Directors of Photography. A user may interact with various functionalities of Search services consistent with various disclosed embodiments via one or more Interfaces (2709).

3^{rd} Party Services

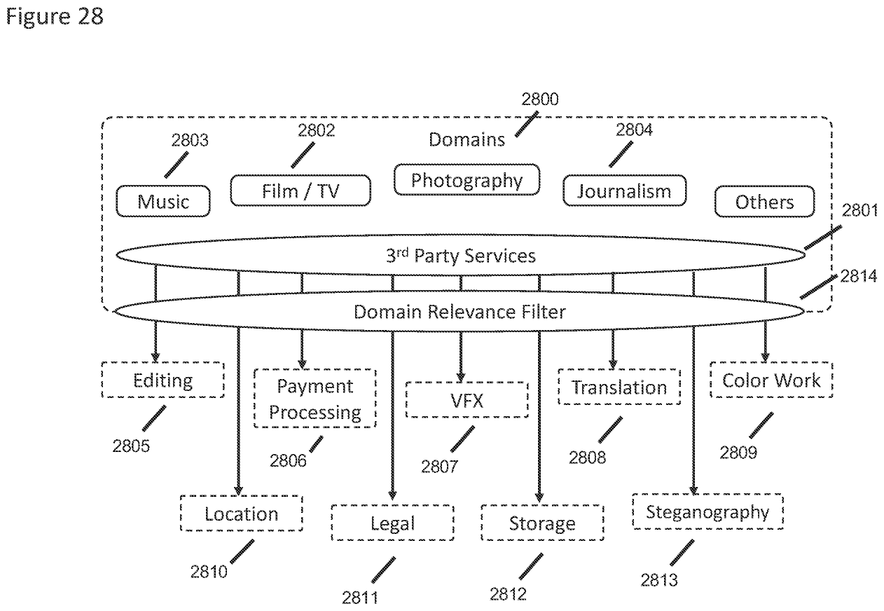

As can be seen in FIG. 28, the proposed architecture can support all manner of external services. Some forms of 3^{rd} Party Services (2801) can be utilized by multiple media ecosystems or Domains (2800) and others are more domain specific. For example, Film and TV (2802) has long had external services—some unique to the domain and others relevant to multiple domains. Editing Facilities, (2805), Payment Processing Services for below-the-line workers (2806), Visual Effects Companies (2807), Translation Services (2808), Color Processing (2809), Location (2810), Legal (2811), Storage (2812), and Steganography (2813) are services that may be used by various studios, networks, producers, and directors. The infrastructure proposed here may in some embodiments provide a dashboard of services filtered for relevance (2814) to the Creative Work at hand. For example, Translation Services (2808) might be for voice over in film but for text in a newspaper article. VFX (2807) might be for painting the lines out of a scene in film but for removing a person from the background of a photo. Payment processing might be one company that handles film and a different company in Music.

Settlement

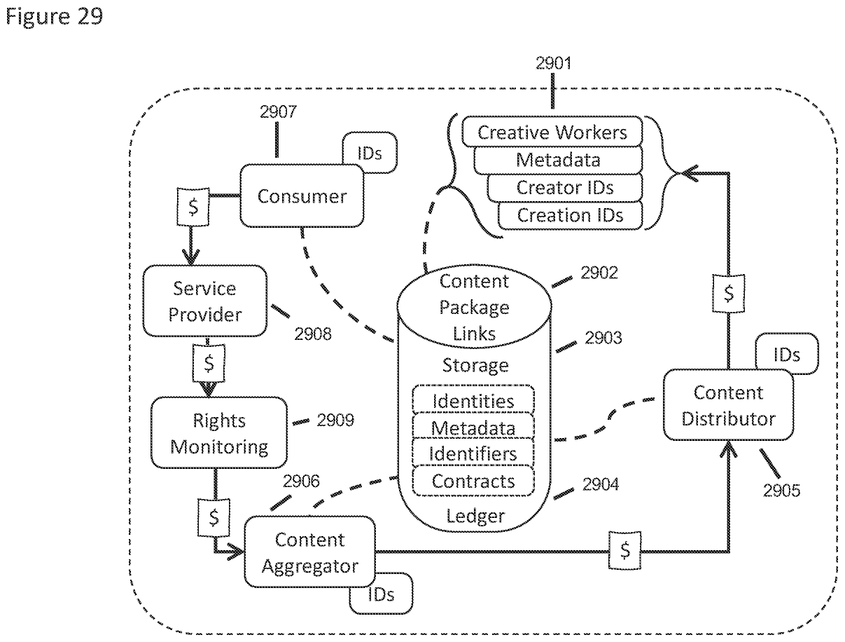

What follows is a breakdown of payment flows and the settlement of other obligations. There is a high-level view in FIG. 29. The remuneration flows generally traverse the same path as the rights but in the opposite direction. We begin with the Creative Workers (2901) who have created the Work. These could be songwriters, performers, directors, actors, authors, journalists, photographers, etc. Once they have deposited their Works, the references, and the metadata in the Storage (2903) and the Ledger (2904) and have created the CPLs (2902), they can be used to reference the content throughout its lifecycle. The same CPL (2902) that is used by Distributors (2905), Aggregators (2906), and Service Providers (2908) can be used to find the Creators, the Identifiers associated with the Works, the Collection Societies, Publishers Guilds and Unions that may remunerate the Creative Workers or their representatives. To understand this in a bit more detail, let's view it from the perspective of the different entities in the ecosystem.

Content Package Links

CPLs (2902) may be the glue that connects the various elements. A CPL (2902) may reference the Content, its Creators, their Rights and Identities, and the Identifiers associated with each Content element.

To understand the power of the CPL (2901), let's look at a couple of non-limiting examples. Suppose a successful photographer has recently died and her heirs have decided to sell the right to license those photographs to a large Photo Aggregator (2906). Before her death, an entity that wanted to use a photograph would have signed a license. That license would have lived in the CS Storage (2903) and been referenced on the Immutable Ledger (2904), which may be distributed. That contract and the images it covered would have referred to the original photographer. Now there is a new contract that points to the Photo Aggregator (2906). The new Agreement with the Aggregator (2906) would reference the old Agreements (e.g., Contracts) and those clauses that were still in force (e.g., existing licenses to use the images) would still be executed. Now suppose someone finds the photo on the Internet or on a billboard (perhaps using a watermark) and want to license that image for an advertising campaign in Japan. That image's metadata may point to its CPL (2902) which would have connected to the original photographer, but which now is dereferenced through the new contract to the new Aggregator (2906).

The terms for licensing the image in the desired territory may be embedded in a smart contract, the new licensee agrees to the terms. Now imagine part of that agreement includes exclusive rights to use the image in Japan for 10 years. Now if a new entity finds the image and follows the CPLs, they will find that they are not able to license in Japan because of the exclusivity of the contract with the advertiser in Japan. Anyone practiced in the art can see how this would work for any kind of content or creator. This could apply to a song or a newspaper article or a script or a novel or a movie or TV show. In this manner, the Creative Objects and their Creators may be linked through the Storage and the Ledgers to dynamically maintain the rights and agreements of the parties.

Let us use another hypothetical example to demonstrate the power of CPLs. Suppose that France has passed a law which governs sync licenses to synchronize songs to Movies and TV shows. Imagine that the law stipulates that, if someone wants to license a song, they must notify the licensor and that if no other licensee is interested in licensing that song, it is licensed at the statutory rate which is 5% of the revenue divided by the percentage of the show in which it is used (this is just a random example but for the sake of argument, say the movie earns $2,000,000 in the 2nd quarter and the music is in 1% of the movie, then 5% of 1% of the $2M is $1,000).

Now when the CPL of the song or of the movie is resolved in France, it may invoke the statute which is in the storage and in the Distributed Ledger. Now suppose the law also stipulates that, if the entities agree on a different rate, that will override the statutory rate. Now suppose, further that the licensor of the song has put it up for bidding with an agreement linked to the CPL of the song and various TV productions bid for the exclusive right to use this song and the highest bidder agrees to a flat fee of $20,000. This may now be embedded in an agreement that (a) overrides the statutory rate and (b) may be linked to the TV show and the song and the performer.

Consumers

Let's look at how this infrastructure may influence Consumers (2907). For purposes of this discussion, a Consumer (2907) may be anyone who consumes content. They might have a music or TV subscription service, or they might view or listen to something that is supported by advertising or receive it as part of a bundle with the purchase of a product or another service. Their consumption of the product could be monitored directly, say by a service that serves the content up to subscribers or approximated based on unmonitored advertisements on say a billboard or on a radio station. The Consumer (2907) might have an explicit agreement as in, say, a subscription service or an implicit one, say with the purchase of a bundled product or a very loosely implied relationship as in the example of driving by a billboard. Further the Consumer (2907) might have negotiated different relationships based on their choices. They might choose to pay a very low or no subscription fee if let themselves be monitored for targeting advertisements. Or they might pay a higher fee for absolute privacy. They might agree to pay a subset of the artists directly when they listen to their music but be allowed to listen to the rest of the music at a bundled price. The point is that embodiments of the system described in this disclosure may support almost any business model—specifically allowing remuneration and data to flow from the consumer to the creator with a detailed degree of control over financial and data flow. A famous actor could allow consumers to follow their personal Vlogs not by having a subscription to them but by stipulating that agreement for any distribution channel to follow. A subscriber could access the Vlog from any service which would have their commission prescribed by the Contract referenced in the Ledger (2904).

Public Facing Services, Distributors, and Agents

The barrier to entry for Public Facing Services (2908) could be extremely low. Once a Content Creator makes their Content available with their stipulated terms, they could allow and public facing service to license that content under those terms (say, for example, an advance against a revenue share valid for a period of x years with a guaranteed renewal rate of y dollars). Public Facing Services (2908) can offer any number of business models to their consumers who can choose freely from any number of different offers.

In the same way Distributors and Agents can offer content from their clients at terms that are defined by their Creators or can create a business model and allow Creators to sign up for distribution services based on that model—either exclusively or not.

Rights Monitoring Entities

Content rights are often monitored by external entities (2909). Some are given this right by statute and some by agreements. Finding the appropriate Creators and their representatives can be challenging. If, for example, a song is recorded by a performer and the performer does not associate that performance with the song, it can be extremely difficult (sometimes nearly impossible) to pay the composer. This may be referred to as “black box” money and can be in the 100s of millions of dollars in the US.

If the system proposed in this disclosure is utilized, there may be no orphaned works as they will be connected from the start. In other industries, there may be limited infrastructure to support individual creators. Journalists can be paid by a news organization but Citizen Journalists (now making a high percentage of news stories) have limited ways to monitor their Works and be remunerated. Utilizing this system may provide an open exchange where Creators can set their own terms and Aggregation Services and Consumers can opt in.

The common rights monitoring entities of today are mostly in the media space. In music they are Performing Rights Organizations (like BMI and ASCAP), in video they are consumer usage monitoring services like the Nielsen Corporation. Aside the lost connections and Black Box monies, these services work reasonably well but they do not readily enable new business models. Digital Rights Monitoring Entities (2909) can aggregate performance or display of Creative Works and remunerate Creators directly under any business model that can be supported by automated contractual obligations. Rights Monitoring entities (2909) can pay Creators directly or pay Content Aggregators (2906) or Content Distributors (2905) or combinations of multiples of the above.

Payment Accounting and Aggregation Services

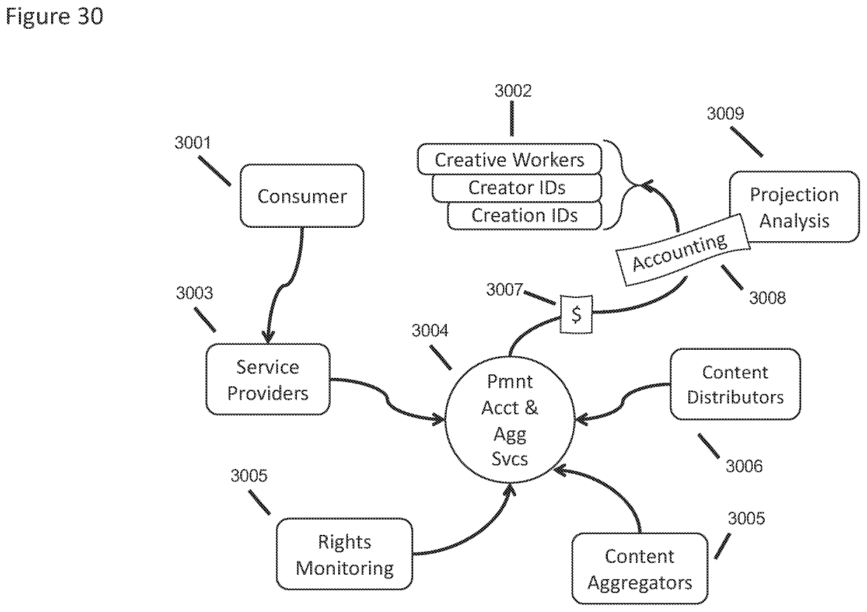

In FIG. 29, we see a complex system of relationships. In some areas like music, payments to a composer/performer can come from many, many entities—perhaps: multiple Record Labels, multiple Performing Rights Organizations, multiple Mechanical Copyright Collectives, multiple Music Publishers, multiple Sync Licensing Agreements, and multiple Foreign Rights monitoring entities. As a culture, we are moving to a system where the free flow of content—globally, can be supported and Creators remunerated, and consumers given a wide array of choices. However, as can be seen in FIG. 30, services may be provided to aggregate the sources of revenue for Creatives (3002).

Using a system like the one proposed in this disclosure, the Creator (3002) of a Creative Work may have the references (CPLs) to their Works available to be aggregated into a dashboard showing all the revenue streams and the remuneration. Beginning with the Consumer (3001), remuneration is paid—either with money or with engagement (e.g., looking at ads, etc.) ultimately to the Creative Workers (3002). However, this remuneration can be captured by multiple parties. First there may be the Service Providers (3003) including entities like Music Streaming Services, Video Streaming Services, TV Networks, Movie Theaters, Newspapers, Magazines, Billboards, Agencies, etc. There are also Rights Monitoring Entities. In Music there may be Performing Rights Organizations and Collective Management Organizations that monitor consumption and pay Creators Directly. In Film and TV there may be Monitoring Entities like Nielsen that track consumer usage which other entities like networks use to determine payments to be made. In Journalism and in other direct to consumer industries like web sites, VLOGs, BLOGs, Podcasts and Social Media payments can come directly from the service provider but Rights Monitoring Entities (3005) can be used to make payments directly through guilds or can be used to influence collective bargaining negotiations.

Some of these services don't pay Creatives directly but pay them indirectly either through Content Aggregators (3005) or through the Content Distributors (3006) like Record Labels, Film Studios, News Services, etc. It may be difficult for Creatives to keep track of all the potential payment entities and to know if they are being properly remunerated. Hence the role of Payment Accounting and Aggregation Services (3004). Because the distribution mechanisms described in this disclosure may be trackable, the services can automatically track payments and aggregate all the payments (3007) from different sources and give Creatives accurate and detailed Accounting (3008) from all the different services. Using historical data (like say, this movie was in x theaters in y territory and so should have an expectation in this time-period of generating z income), Projection Analysis Services (3009) can predict payment expectations for planning purposes and also flag anomalies that might indicate missing payments.

### Recommendation Ecosystem Implementation Examples

As discussed above, various embodiments of the disclosed systems and methods may provide techniques for managing recommendation services and/or compensating participants. In some embodiments, recommenders together may create an ecosystem with their own hierarchy and value. For those recommenders who can correctly recommend creators that end up generating revenue for the system, there can be revenue participation. For example, if a Recommender finds a great songwriter and that songwriter goes on to generate revenue, the application that facilitates that revenue can share a portion of that revenue with the Recommender.

In order to improve and/or otherwise optimize the system, we cannot go on volume alone—one could not, for example, succeed by giving everyone a top rating. Accordingly, recommendation compensation algorithms may take incorrect ratings into account. Also, there may be numerous people who rate a very talented person highly and so any remuneration generated from those ratings may be shared but not necessarily evenly. Various embodiments of the disclosed systems and methods may value a Recommender based on how many Recommendation Credit Points they have.

Further embodiments may offer a mechanism whereby creators of a basic creative element like a drawing or a textual story allow others to use that basic as part of their own creation and the creator of the original component may be credited and/or remunerated for further uses of that element.

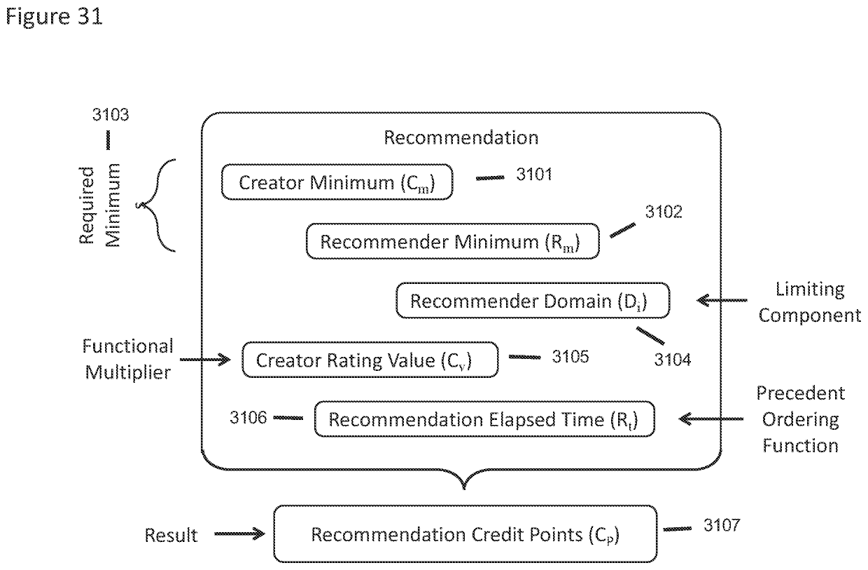

FIG. 31 shows a high level breakdown of various elements in a non-limiting example of a recommendation engine consistent with certain embodiments disclosed herein. Various embodiments of the engine may be used to, for example and without limitation, determine a number of recommendation credit points. It will be appreciated that although various elements in FIG. 31 and elsewhere herein may use to the term “required,” this usage should not be viewed as limiting. Indeed, a “required” threshold (e.g., a minimum number of required recommendations) for a particular implementation may vary between different implementations, circumstances, settings, times, applications, and/or the like. Therefore, any specific indications of a “required” threshold and/or value included in the figures or elsewhere herein should be viewed as a non-limiting example of a threshold and/or value.

Consistent with various disclosed embodiments, the following elements may determine a number of Recommendation Credit Points:

Creator Minimum number of recommendations required (3101): In some embodiments, to have the scale for the system to work, any Creator considered may have a minimum number of Recommenders. We will call that C_{M}.

Recommender Minimum number of recommendations required (3102): In some embodiments, for a reviewer to be considered a viable Recommender, they may have at least one recommendation. However, to limit the noise, in some embodiments that number may be higher or perhaps much higher than 1. We will call that R_{M}.

Recommender Minimum and Creator Minimums (3103): These establish minimums to be met in order for a Recommender to earn points. In some embodiments, these established points are also limited by the Domain of the recommendation.

Recommender Domain (3104): A Rater might have very high marks in predicting great songwriters but lower marks in predicting great camera operators. Accordingly, in some embodiments, ratings may be limited to the Domain of Inquiry—D_{(I)} where I is the name of the domain (e.g., Songwriter, Director of Photography, Screenwriter, etc.)

Creator Rating Value (3105): Based on the historical accuracy of the Reviewer, a rating value, R_{V} may be generated. This may be a reflection of how accurate the Reviewer has been in predicting talent within a specific domain.

Recommendation Elapsed Time (3106): Earlier recommendations may, in some embodiments, be worth more. For example, the value of the recommendation may be weighted based on how many minutes have elapsed between the recommendation and the Cutoff Time—that is when the analysis is done. In certain implementations, the more time is better. R_{T} may represent the number of minutes between the time of the recommendation and the time.

Recommendation Credit Points (3107): The number of Credit Points (C_{P}) associated with a Creative Work or with a Creator is calculated by a using one or more algorithms that take into account one or more of: Creator Minimum (C_{M}), Reviewer Minimum (R_{M}), Creator Rating Value (C_{V}), Recommender Domain (D_{I}), and/or Recommendation Elapsed Time (R_{T}).

Though there are many possible formulas that can be created by using this data in different ways, at least one non-limiting example may be:

### IF: Creator Minimum is >C_{M}

### AND: Reviewer Minimum is >R_{M}

### THEN: Recommendation Credit Points (C_{P})

### WILL BE A FUNCTION OF: Creator Rating Value R_{V}

TIMES: the % of proximity to the Recommender Domain (D_{I})
TIMES: the inverse of the Recommendation Elapsed Time R_{T}

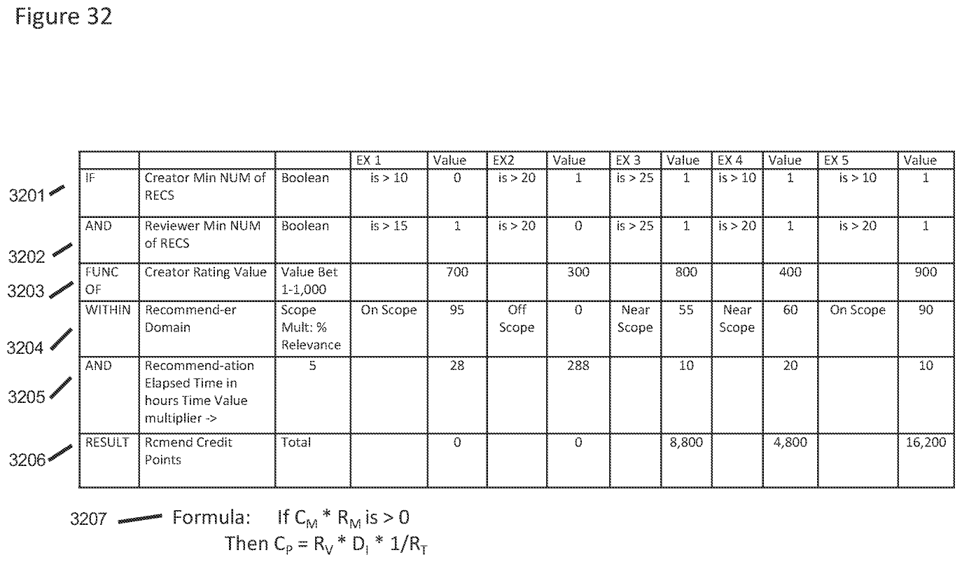

FIG. 32 shows a non-limiting example of worksheet that may be used to demonstrate how Recommendation Credit Points may calculated consistent with certain embodiments disclosed herein.

In the illustrated example worksheet, the first row (IF, 3201) may represent the threshold minimum number of Creator recommendations to be considered. In example 1, that number should be greater than 10 and since the Recommender in example 1 has less than 10 recommendations, it may fail the test and be associated with a Boolean value of 0. In the second example, the Recommender should have more than 20 recommendations and since they have this number, they may pass and be associated with a Boolean of 1. Examples 3, 4, and 5 have above the threshold number of Creator Recommendations and so they pass and may be associated with a Boolean value of 1.

The second row (AND, 3202), may represent the threshold minimum number of Reviewer recommendations the Reviewer has made. For example, if the Reviewer has only made one recommendation, one might decide that a successful recommendation was just luck and not include it. In FIG. 32, the examples 1, 3, 4, and 5 meet the criteria and may thus be associated with a Boolean value of 1.

The third row (FUNCTION OF, 3203) may represent the Creator Rating Value, which may be similar in some respects to a batting average of accuracy. If the recommender correctly picked every recommendation they made, the would be batting 1000. If they were right half the time, the would be batting 500. In our example, the rating value for example 1 is 200, example 2 is 300, example 3 is 800, example 4 is 400 and, example 5 is 900.

The fourth row (WITHIN, 3204) may be to consider how close to the domain the recommenders area of expertise is. For example, a Director of Photography is particularly expert at knowing a good camera operator whereas an accountant's opinion might be less relevant. In our grid, the relevance of domain is treated as a % from 0 to 100. In our example, the rating relevances are for example 1 is 95, example 2 is 0, example 3 is 55, example 4 is 60 and, example 5 is 90.

The fifth row (AND, 3205) may represent the inverse of the elapsed time in hours. That is, in some embodiments, the earlier one makes a positive recommendation, the more value it has. The 3rd cell in that row represents a multiplier. One using the system might determine the earliness has a relative low value for some things but for others, being early has more value. In our example, the value in this cell is 5 which means that the cell multiplies the relevance by ⅕^{th}. As a result, the values for our examples 1 through 5 are: 28, 288, 10, 20 and 10. Though not in this example, earliness could be a variable function. For example, the most valuable amount of time to choose a comic might be 3 months. 3 months could be the top of a bell curve (e.g., most valuable) with the curve falling to a very low value if the recommendation is very recent (e.g., because they are already hearing from others) and a very low rate earlier than a certain date. These algorithms could be tried in different ways over time to provide value and could be developed using AI to determine retroactively (e.g., based on success data) what the shape of the curve should actually be—and it could easily be different for different categories of workers or reviewers.

The last row (RESULT, 3206) is our results row where we show the number of Recommendation Credits. Examples 1, 2 and 4 are zero because one or both of their Boolean values was zero.

The value of Recommendation Credits for example 3 is 8,800, for example 4 is 4,800 and for example 5 it is 16,200. So the recommender's recommendation with regard to the person or item being recommended for example 5 is higher.

In various embodiments, the Recommendation Credits may be calculated according to formula (3207):

If C_{M}*R_{M} is >0

Then C_{P}=R_{V}*D_{I}*1/R_{T}

It will be appreciated, however, that Recommendation Credits may be calculated in a variety of other suitable ways.

Next is to take the Recommender Credit Points (C_{P}) and apply them to the creators. The example we are using is applied to songwriters but one practiced in the art could easily apply the same logic to filmmakers or journalists or photographers.

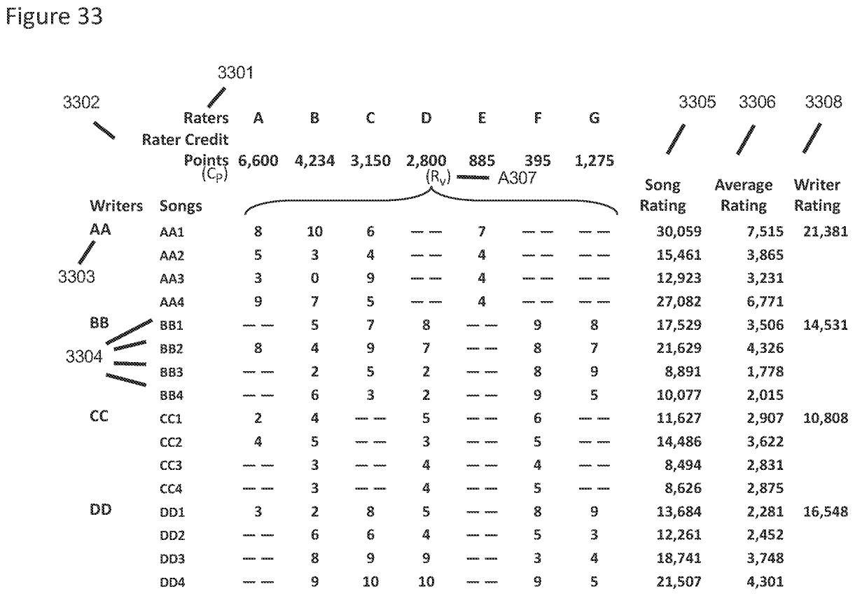

FIG. 33 shows a non-limiting example of a worksheet that may be used to demonstrate how song ratings and writer ratings may be calculated consistent with certain embodiments disclosed herein. Looking at the worksheet illustrated in FIG. 33, we see the top row (3301) lists the individual raters or, in the case of music, people who are listeners who rate the songs. The Raters labeled on the top row are: A, B, C, D, E, F, and G. Each Rater's Recommender Credit Points may be calculated as described above. These are listed in the second row (3302) and may be derived from a worksheet similar to the one in FIG. 32. In the first column, we have listed the songwriters (3303), writers AA, BB, CC, and DD. In the second column are the titles of the songs (3304), AA1, AA2, AA3, AA4, BB1, BB2, etc. Now we are going to apply our Rater recommendation Points scores to individual creations to generate Song Ratings (3305). Because more raters would add up to more points, we may average the rating (3306) to compensate for this. Finally we may also average the Song Ratings of each of the individual creators (writers, 3304) to generate the Writer Ratings (3307) using the algorithms described below.

Drilling down a bit more in the details of the example shown in FIG. 33: First we multiply the value of each Rater's Recommender Credit Points (C_{P}) (3302) by the value each Rater gave to each song (R,) (A307). In the case of Writer AA with regard to their song AA1, Raters A, B, C, and E rated the songs, respectively at 8, 10, 6, and 7 which gives us a composite score for recommended value of the quality of the song. In the case of song AA1, this value (as seen in FIG. 33) is 30,059. We then divide this by the number of songs rated by each for an average Song Rating (Rs) (3305) of 7,515. In Summation, our new formula may be expressed as:

(Rᵥ)*(R_{S})/# of songs rated.

To demonstrate in connection with the illustrated example Song AA1 was rated by raters with the associated Credit Points A (6,600), B (4,234), C (3,150), and E (885) with the following ratings for AA2 of (8) (10) (6) (70), yielding the average song rating for song AA1 of 7,515.

In some creative disciplines (like song writing or screenplay writing, or others), a straight mean, median or mode may not give a desired result. If you write 100 flops but 3 smashes, you are a genius but if you write 100 “good” songs or plays or whatever, you are just OK. One approach would be to discard a percentage of lowest rated songs when determining writer rating. So the averaging algorithm may be variable. Even if you do this with AI, you may need to know what you are looking for. A straight average that is good might be valuable if you are looking for a co-writer who will be a solid participant while the occasional genius might be more what is wanted if you are willing to take high risk with potential high return. Note, this may not affect the value of the individual creative work (song, play, painting, etc.) which may be based on the value of the reviews and the reviewers.

Again, we are using songs as our example but one practiced in the art can easily apply the same logic to other fields such as film, graphic design, photography, journalism or any other creative endeavor.

Recommenders and Remuneration

Now that we know how accurate each reviewer is, we can use that to determine the value of their recommendations with the idea being that recommenders who are more accurate in their recommendations, and who's recommendations result in the discovery of creatives who generate revenue, can participate in some share of that revenue.

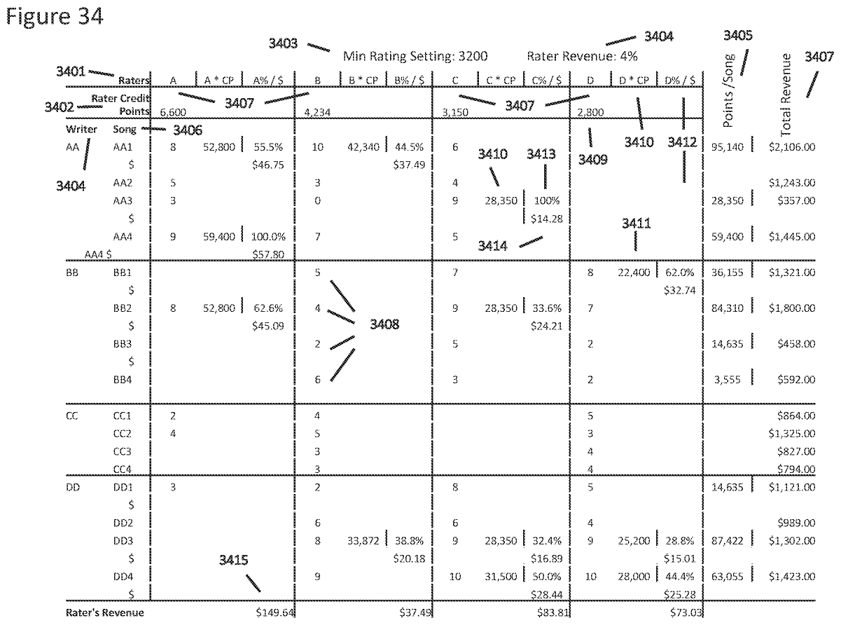

We may take much of the data from FIG. 34 such as the Raters (3401) and the Rater Credit Points (3402) and reconfigure the data and work with it in FIG. 34, which shows a non-limiting example of a worksheet that may be used to demonstrate how Ratings can be compensating for users who select the best rated works consistent with certain embodiments disclosed herein. A Minimum Rating Setting (3403) may be used to eliminate those with a low rating as a Rater. Here we have arbitrarily set it to a rating of 3,200. This means that anyone with a rating below 3,200 may not participate in the revenue.

In order to simplify the diagram, we have removed all the raters that were in the worksheet of FIG. 34 that had a rating below 3,200. In order to calculate the rater's revenue share we are using a Rater Revenue Number (3404) to represent the percentage of revenue that is their participation. We have chosen 4% just as a non-limiting example. Not only could the percentage be any number but there are any number of mechanisms that could influence how this number works. One could apply a different % based in the number of recommendations, the time one has been a recommender, the degrees of separation on a social network, etc.

It could be on net as opposed to gross or literally any metric that experience brings about. For this example, we chose a straight 4% for simplicity. There may be a column (3405) taken from the previous worksheet that shows the cumulative points generated in favor of each song (3406). The final column is the Total Revenue (3407) generated by each song. Rater Name columns A, B, C and D (3407) show the Rating Points on a scale from 1 to 10 (3408) that each rater has given each work (e.g., a song, 3406) or a graphic design or newspaper article or a photograph, etc. In the second row, near the top of the Rater Name Column (3402) are the Rater Credit Points. In the case of Rater D (3409), it is 2,800. The next column D*CP (3410) is the Song Rating given to a song by reviewer D multiplied by Reviewer D's Rater Credit Points. So, for the four Raters represented in this figure (A, B, C and D) we show the product of their song ratings times their rater rating (Rater Credit Points) in the four columns: A*CP, B*CP, C*CP, and D*CP.

Looking down the column D*CP for Rater D to the row for song BB1, we see the rating, 8, which is multiplied by D's Rater credit Point score which is 2,800 totaling 22,400 (3411). The columns to the right of the product columns (3412) serve two purposes. This column (3413) shows the percentage of the Rater's share of the sufficiently positive recommendation and below it (3414) is the revenue that it represents as a percentage of the total revenue (column 3407). So, for example, looking at the row for song AA1 by writer AA, we see that Rater A rated the song as an 8 on a scale of 10, Rater B rated it a 10. Rater C rated it a 6 but since 6 falls below the Minimum Rating Setting of 3,200, Rater C may not participate in the revenue calculation. In this simplified example (it will be appreciated that in further implementations, there might be hundreds or thousands of Raters participating in the revenue calculation), Rater A earns 55.5% of the revenue share (4%, 3404) or $46.75 and Rater B earns 44.5% or $37.49. In this example, we can see that Rater A has the best record across multiple songs and earns a total of $149.64 (3415).

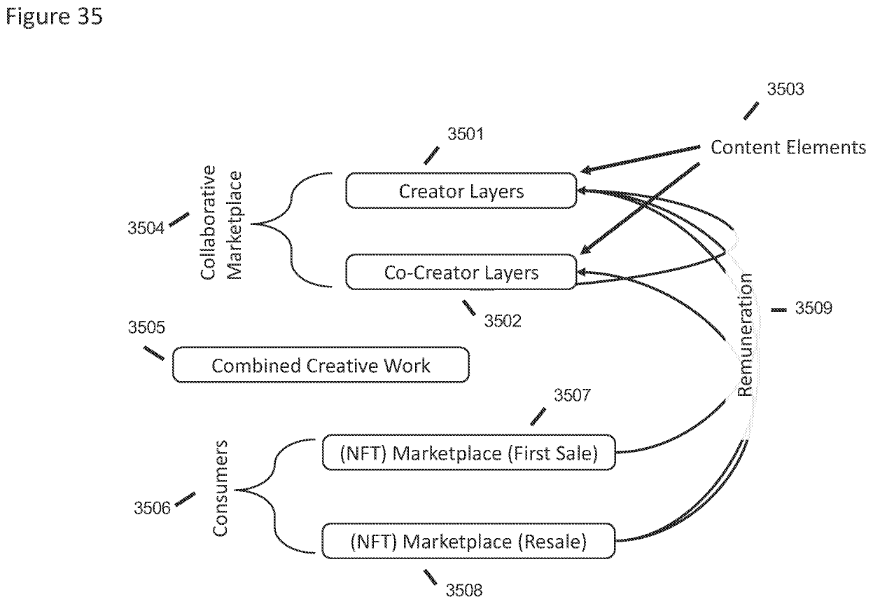

FIG. 35 illustrates a non-limiting example of components for collaborators and/or consumers consistent with certain embodiments disclosed herein. The basic idea of certain embodiments of the disclosed systems and methods may be as follows: Someone creates a component of a work (3501), perhaps a background that can be used in a graphical work and they allow others to build upon that work creating a composite work that includes the original work. That work may be made available for others to build on top of (3502). These Content Elements (3503) may be made in a Collaborative Marketplace (3504). The result of these collaborations are Combined Creative Works (3505) that can be made available to Consumers (3506) in a Marketplace, potentially a Non-Fungible Token Marketplace (3507). In that Marketplace, these Consumers (3506) can Re-sell those Creative Works (3505) to other consumers and not only with the final Creator of the Creative Work (3502) receive Remuneration (3509) but the original creator can receive a portion of that remuneration (3509).

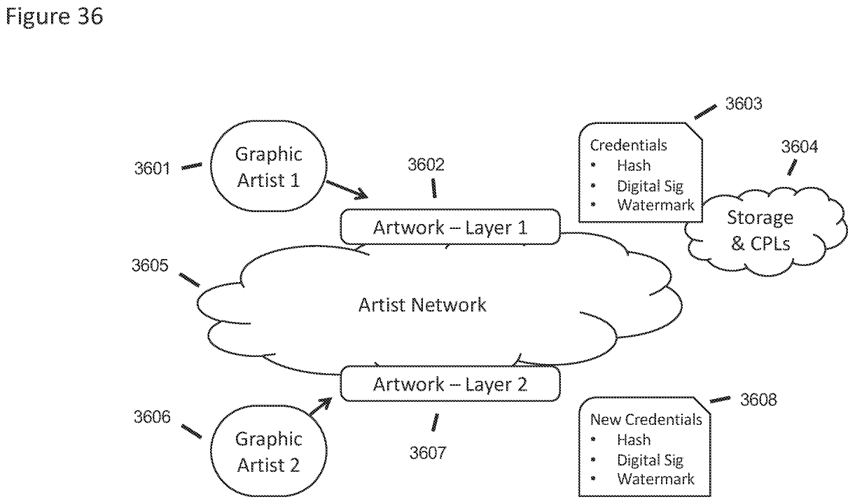

Now, looking at FIG. 36, which shows further non-limiting examples of a creator ecosystem, let's apply a bit more detail. Suppose I am a graphic artist (3601) and I have created some backgrounds—say a perfect sunset or a brick wall ripe for graffiti. Now suppose I want to make these backgrounds available for others to add things on top. Let's call this initial Artwork Layer 1 (3602). I need to identify this piece of work immutably so I hash it, I sign it and perhaps I watermark it (3603). Now, any time that layer is used, I have an immutable record of its original form. With the exception of the possible watermark, this may not be designed to prevent privacy but rather to confer attribution and tracking. If for example, someone else wants to use that background, Artwork Layer 1 (3602) the elements and the attribution are tied to the artwork. In fact the hash and signature can be used with a CPL (3604) to reference back to the creator of Artwork Layer 1 (3601). The Storage And CPL component (3604) can also contain contracts that can be used for people who want to license the Artwork Layer 1 (3602) elements.

For example, using a Smart Contract, I might define the terms that there is a small fee for using the artwork and percentage of any revenue generated from using it. Suppose I have created the background sky that is used as the logo for a major airline. When they hire an artist to create an ad campaign, they might hash them to use their standard background and when the new artist is paid, the original artist might receive a percentage of the fee or a separate fee or a credit—anything that has been agreed to in the smart contract.

Let's further imagine that I have taken my Layer 1 Artwork (3602) and I have put it out in an Artist Social Network (3605) where others an find it and license it for use in their own creations. They would be able to see the terms stored in the Storage and CPL Cloud (3604) and agree to the terms. Now this second artist—Graphic Artist 2 (3606) creates a derivative work we are calling Artwork Layer 2 (3607)—it might be a separate Layer as that is how many graphics programs work but it might also be a metaphorical layer. For the purposes of this disclosure, either apply. The last step in this process is to create Credentials (3608) that immutably represent both the combined work and also just the new portion of the work—say Graphic Artist 2 (3606) want to license their layer to other artists—embodiments of the disclosed system may facilitate that.

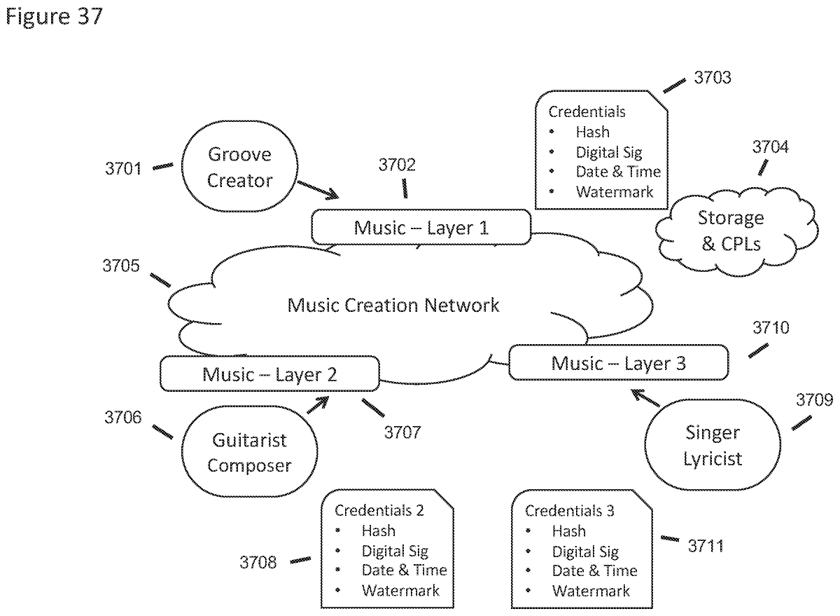

In order to clarify the construction, let's look at FIG. 37 which illustrates further non-limiting examples show similar mechanisms as applied to music. As will be appreciated to one of ordinary skill in the art, this may be applied to any number of other media; journalism, photography, film making, architecture, 3D printing, etc.

For our first creative layer, let's start with a content creator who creates a drum track based on an original groove (rhythm plus feeling). This is Music Layer 1 (3702) created by the Groove Creator musician (3701). Just like in the graphics example, the media—in this case audio—perhaps multiple channels of different instruments making up a single groove—may be hashed and signed and perhaps watermarked (3703) and stored in the cloud (3704) and CPLs are created. These CPLs may be stored in a Music Creation Network (3705) where people with permissions can hear the groove. When the select the CPL it may actually trigger a stream from the Storage (3704). Of course, the files themselves could be stored in the Music Creation Network (3705) but may not necessarily change the basic mechanism. This could be like a cache that was periodically synchronized with the primary and “official” file that lives in the Storage and CPLs repository (3704) which is often, of course distributed with the CPLs likely living on the block chain though there is nothing in the architecture that requires a distributed ledger and the same functionality could be acquired with a simple database but an efficient and secure method would be to use a distributed ledger like a block chain.

Now, let us assume for the second layer that a guitarist/composer (3706) likes the groove in Music Layer 1 and decides to write a set of chords and melody to that groove this creating Music Layer 2 (3707). This new layer and the combination of both layers are hashed and signed in a new set of credentials (3708) and stored in the Storage and CPLs (3704). There is now a digital record of not only what the guitarist/composer added but when it was added.

Following a similar approach as before, this new work—the groove plus the chords and melody—is referenced and possibly stored in the Music Creation Network (3705) perhaps with a message asking for a singer and/or a lyricist to complete the song. Now suppose a singer/lyricist (3709) writes some lyrics and sings them and creates Music Layer 3 (3710). This individual element may be stored, hashed and signed, and perhaps watermarked (3711) as is the combination of the three elements.

There is now, as registered on the distributed immutable ledger (or in a database) a complete record of the chain of creation of the collective work. In the process, there would also be licenses signed ascribing attribution and potential revenue share that would also be stored in the Storage and CPLs and the Distributed Ledger. To be clear, the elements do not have to be stored in the same location and there could be one ledger with contracts and another with files and yet another with metadata and/or credentials.

Various aspects of the disclosed systems and methods and/or associated disclosed embodiments may be applied in a variety of markets, contexts, examples, and/or use cases including, for example and without limitation, one or more of:
3D printing; I make a cup, you make a saucer, I design a house frame, you design windows and doors, I make a carburetor, you design an engine.
Film; I take your script and get funding, I upload a scene and you add the VFX, I upload the dialog and you do the translation.
Journalism; I upload the picture, you write the story, I upload the story you edit it (the same works for books, magazines and journals).
Game design; I design a game and you create characters (or vice versa).

In short, various aspects of the disclosed systems and methods may add accountability to a variety of creative arts.

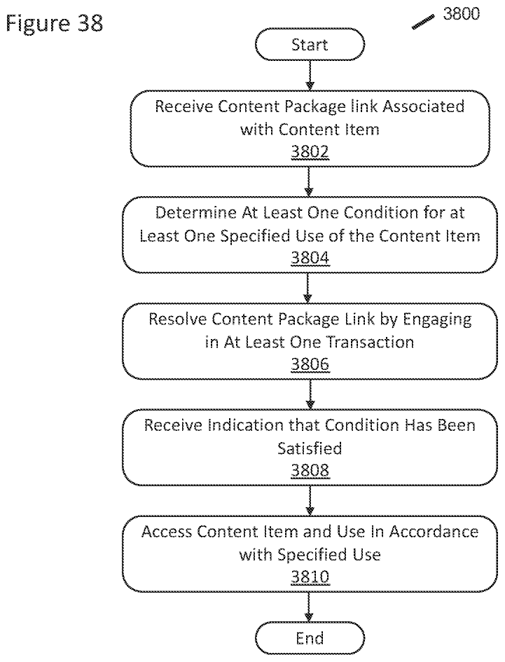

FIG. 38 illustrates a flow chart of a non-limiting example of a content management process 3800 consistent with certain embodiments disclosed herein. The illustrated process 3800 may be implemented in a variety of ways, including using software, firmware, hardware, and/or any combination thereof. In certain embodiments, various aspects of the process 3800 and/or its constituent steps may be performed by one or more systems, devices, components, and/or services, including any systems, devices, components, and/or services and/or any combination thereof that may be used in a content management architecture as described herein. Consistent with various disclosed embodiments, the content management process 3800 may be used to manage various interactions in connection with a content item, which may comprise, for example and without limitation, one or more of text content, audio content, video content, image content, 3D printing content, digital object content, and/or any other type of content and/or combinations thereof.

At 3802, a CPL may be received in response to a request to access a content item. In various embodiments, the CPL may be cryptographically bound to the content item using a variety of techniques. For example and without limitation, the CPL may be cryptographically bound to the content item via one or more digital signatures and/or generated hashes, which may be verified and/or otherwise authenticatable.

In certain embodiments, the CPL may be received from an immutable ledger, which in some embodiments may comprise a distributed immutable ledger. In some embodiments, a blockchain ledger may be used.

The CPL may comprise, for example and without limitation, at least one content identifier, content creator identifier, and/or indication of first rights contentions associated with the content item. The at least one content identifier may comprise, for example and without limitation, one or more of an ISRC identifier, an ISWC identifier, a DOI, an ISBN, an EIDR identifier, an ISAN, and ISCC identifier, and/or any other identifier, which may be a standardized identifier. It will be appreciated that a wide variety of identifiers may be used in connection with content items consistent with various aspects of the disclosed embodiments, and that any suitable content identifier and/or identifiers may be used. In certain embodiments, the at least one content identifier may comprise an identifier unique to the content item that may be generated, at least in part, based on the content item (e.g., a hash of the content item and/or the like). In some embodiments, the content identifier may comprise an indication of a location to access an electronic file corresponding to the content item.

Based on the indication of the first rights conditions included in the CPL, at least one condition for at least one specified use of the content item may be determined at 3804. In certain embodiments, the at least one condition may be specified in the indication of the first rights conditions. In further embodiments, the indication of the first rights conditions may specify a location to access the indication of first rights from a rights management entity.

At 3806, the CPL may be resolved by engaging in at least one electronic content usage transaction (e.g., rental, purchase, engaging in a transaction to obtain certain rights to the content, etc.) to satisfy the at least one condition for using the content item. An indication may be received from a rights management entity associated with the content item (e.g., a digital rights management service and/or the like) that the at least one condition for using the electronic content has been satisfied by the content usage transaction. In certain embodiments, pre-authentication processes may be performed. For example, as part of a pre-authentication process, a user system may receive a token and/or other electronic credential, which may be used to satisfy certain rights and/or obligations determination processes. Consistent with various embodiments disclosed herein, possession of the token and/or electronic credential may be used to demonstrate that certain usage conditions for the electronic content item have been satisfied.

The content item may be accessed using the CPL and may be used in accordance with the at least one specified use of the content item at 3810. In various embodiments, CPLs may be updated. For example, in some embodiments, an update to a CPL may be received (e.g., an update comprising an indication of second rights conditions associated with the content item). An updated CPL may be generated based on the received update to the CPL and provided to a ledger managing CPLs associated with content items.

Computer and/or Software Implementations

Various aspects of the disclosed systems and methods may be implemented by one or more computing devices and/or systems. The various systems and/or devices used in connection with aspects the disclosed embodiments may be communicatively coupled using a variety of networks and/or network connections (e.g., network). In certain embodiments, the network may comprise a variety of network communication devices and/or channels and may utilize any suitable communications protocols and/or standards facilitating communication between the systems and/or devices.

The various systems and/or devices used in connection with aspects of the disclosed embodiments may comprise a variety of computing devices and/or systems, including any computing system or systems suitable to implement the systems and methods disclosed herein. For example, the connected devices and/or systems may comprise a variety of computing devices and systems, including laptop computer systems, desktop computer systems, server computer systems, distributed computer systems, smartphones, tablet computers, and/or the like.

In certain embodiments, the systems and/or devices may comprise at least one processor system configured to execute instructions stored on an associated non-transitory computer-readable storage medium. The systems and/or devices may further comprise software and/or hardware configured to enable electronic communication of information between the devices and/or systems via a network using any suitable communication technology and/or standard. The operation of the one or more systems and/or devices in connection with various aspects of the disclosed systems and/or methods may be generally controlled by a processing unit operating by executing software instructions and programs stored in system memory (and/or other computer-readable media, such as memory, which may be removable).

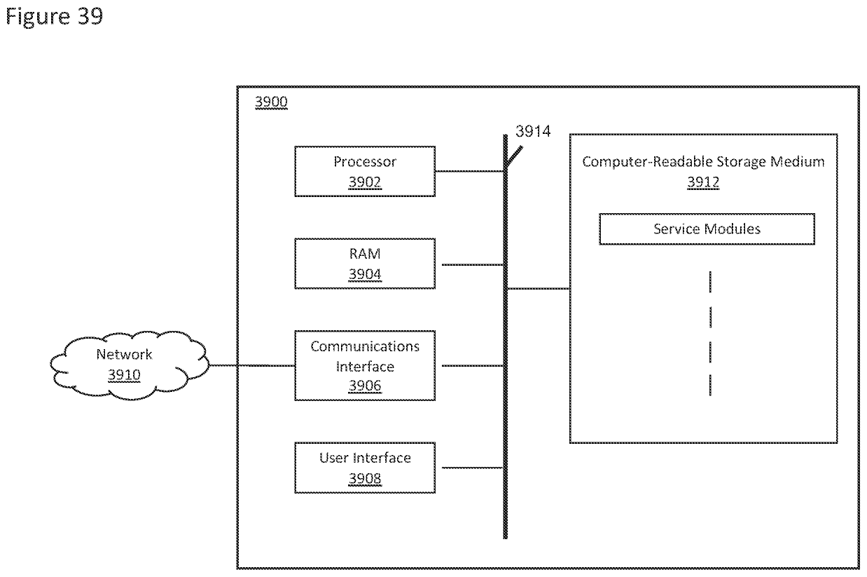

FIG. 39 illustrates a non-limiting example of a system 3900 that may be used to implement certain embodiments of the systems and methods of the present disclosure. In certain embodiments, the system 3900 may comprise a CS, and/or any other system, device, and/or component used to implement various services and/or functionalities and/or aspects thereof of a content management architecture consistent with various disclosed embodiments. In certain embodiments, the system 3900 may be a personal computer system, a server computer system, and/or any other type of system suitable for implementing the disclosed systems and methods. In further embodiments, the system 3900 may be any portable electronic computer system or electronic device including, for example, a notebook computer, a smartphone, and/or a tablet computer.

As illustrated, the computer system 3900 may include, among other things, one or more processors 3902, random access memories (“RAM”) 3904, communications interfaces 3906, user interfaces 3908, and/or non-transitory computer-readable storage mediums 3912. The processor 3902, RAM 3904, communications interface 3906, user interface 3908, and computer-readable storage medium 3912 may be communicatively coupled to each other via a data bus 3914. In some embodiments, the various components of the system 3900 may be implemented using hardware, software, firmware, and/or any combination thereof.

The user interface 3908 may include any number of devices allowing a user to interact with the system 3900. For example, user interface 3908 may be used to display an interactive interface to a user, including any of the visual interfaces disclosed herein. The user interface 3908 may be a separate interface system communicatively coupled with the system 3900 or, alternatively, may be an integrated system such as a display interface for a laptop or other similar device. In certain embodiments, the user interface 3908 may comprise a touch screen display. The user interface 3908 may also include any number of other input devices including, for example, keyboard, trackball, and/or pointer devices.

The communications interface 3906 may be any interface capable of communicating with other computer systems and/or other equipment (e.g., remote network equipment) communicatively coupled to system 3900. For example, the communications interface 3906 may allow the system 3900 to communicate with other computer systems (e.g., computer systems associated with external databases and/or the Internet) via one or more network connections 3910, allowing for the transfer as well as reception of data from such systems. The communications interface 3906 may include, among other things, a modem, an Ethernet card, and/or any other suitable device that enables the system 3900 to connect to databases and networks, such as LANs, MANs, WANs and the Internet.

The processor 3900 may include one or more general purpose processors, application specific processors, programmable microprocessors, microcontrollers, digital signal processors, other customizable or programmable processing devices, and/or any other devices or arrangement of devices that are capable of implementing the systems and methods disclosed herein. The processor 3902 may be configured to execute computer-readable instructions stored on the non-transitory computer-readable storage medium 3912. The computer-readable storage medium 3912 may store other data or information as desired. In some embodiments, the computer-readable instructions may include computer executable functional modules configured to implement various services, functions, and/or activities disclosed herein. For example, the computer-readable instructions may include one or more executable modules configured to implement all or part of the functionality of the systems and methods described above.

It will be appreciated that embodiments of the system and methods described herein can be made independent of the programming language used created the computer-readable instructions and/or any operating system operating on the computer system 3900. For example, the computer-readable instructions may be written in any suitable programming language, examples of which include, but are not limited to, C, C++, Visual C++, and/or Visual Basic, Java, Perl, or any other suitable programming language. Further, the computer-readable instructions and/or functional modules may be in the form of a collection of separate programs or modules, and/or a program module within a larger program or a portion of a program module. The processing of data by system 3900 may be in response to user commands, results of previous processing, or a request made by another processing machine. It will be appreciated that system 3900 may utilize any suitable operating system including, for example, Unix, DOS, Android, Symbian, Windows, iOS, OSX, Linux, and/or the like.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. For example, it will be appreciated that a number of variations can be made to the various embodiments, systems, services, and/or components presented in connection with the figures and/or associated description within the scope of the inventive body of work, and that the examples presented in the figures and described herein are provided for purposes of illustration and explanation, and not limitation. It is further noted that there are many alternative ways of implementing both the systems and methods described herein. Accordingly, the present embodiments are to be considered as illustrative and not restrictive, and the embodiments of the invention are not to be limited to the details given herein, but may be modified within the scope and equivalents of the appended claims.

What is claimed is:

1. A method for managing content performed by a system comprising one or more processors and a non-transitory computer-readable memory containing instructions executed by the one or more processors that cause the system to perform the method, the method comprising:
receiving, in response to a request to access a content item, a content package link, the content package link being cryptographically bound to the content item, the content package link comprising:
at least one content identifier,
a content creator identifier, and
an indication of first rights conditions associated with the content item;
determining, based on the indication of first rights conditions included in content package link, at least one condition for at least one specified use of the content item;
resolving the content package link by engaging in at least one electronic content usage transaction to satisfy the at least one condition for using the content item;
receiving, from a rights management entity associated with the content item, an indication that the at least one condition for using the electronic content has been satisfied by the at least one electronic content usage transaction;
accessing the content item using the content package link; and
using the accessed content item in accordance with the at least one specified use of the content item.

2. The method of claim 1, wherein the at least one condition for the at least one specified use of the content item is specified in the indication of first rights conditions associated with the content item.

3. The method of claim 1, wherein the indication of first rights conditions comprises an indication of a location to access the at least one condition for the at least one specified use of the content item from a rights management entity.

4. The method of claim 1, wherein the content package link is cryptographically bound to the content item via at least one cryptographic signature, and wherein the method further comprises verifying the at least one cryptographic signature.

5. The method of claim 1, where the content package link is cryptographically bound to the content item via a hash associated with the content package link, the hash being generated based on the content package link and the content item, and wherein the method further comprises verifying the hash based on the content package link and the content item.

6. The method of claim 1, wherein the content package link is received from an immutable ledger.

7. The method of claim 6, wherein the immutable ledger comprises a blockchain ledger.

8. The method of claim 6, wherein the immutable ledger comprises a distributed immutable ledger.

9. The method of claim 1, wherein the at least one content identifier comprises an indication of a location to access an electronic file corresponding to the content item.

10. The method of claim 1, wherein the at least one content identifier comprises one or more of an International Standard Recording Code identifier, an International Standard Work Code Identifier, a Digital Object Identifier, an International Standard Book Number identifier, an Entertainment Registry identifier, an International Standard Audiovisual Number identifier, and an International Standard Content Code identifier.

11. The method of claim 1, wherein the at least one content identifier comprises a hash of the content item.

12. The method of claim 1, wherein engaging in at the least one electronic content usage transaction and receiving the indication that the at least one condition for using the electronic content item has been satisfied are performed as part of a pre-authentication process.

13. The method of claim 12, wherein the indication that the at least one condition for using the electronic content item has been satisfied comprises at least one authentication token.

14. The method of claim 1, wherein the method further comprises:
receiving an update to a content package link; and
generating an updated content package link based on the received update to the content package link.

15. The method of claim 14, wherein the update to the content package link comprises an indication of second rights conditions associated with the content item;

16. The method of claim 14, wherein the content package link is received from an immutable ledger and wherein the method further comprises transmitting the updated content package link to the immutable ledger.

17. The method of claim 1, wherein the content item comprises at least one of text content, audio content, video content, image content, 3-dimensional printing content, and digital object content.
